(19) United States
(12) Patent Application Publication
(10) Pub. No.: US 2008/0144612 A1
(43) Pub. Date: Jun. 19, 2008

(54) Flexible radio resource sharing in time and frequency domains among TDD communication systems

(75) Inventors: Zhi-Chun Honkasalo, Kauniainen (FI); Che XiangGuang, Beijing (CN); Petri Jolma, Nurmijarvi (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/637,982

(22) Filed: Dec. 13, 2006

(51) Int. Cl. H04Q 11/04

(52) U.S. Cl. 370/370

(57) ABSTRACT

A method includes communicating a number of first frames using a first communication scheme. Each of the first frames has one or more first active time periods. Communication of the first frames uses a first frequency band. The method includes communicating a number of second frames using a second communication scheme. Each of the second frames has one or more second active time periods. Communication of the second frames uses a second frequency band that at least partially overlaps the first frequency band. The communication of the first frames and communication of the second frames operate so that at least a portion of the first and second frames overlap in time but the first and second active time periods do not overlap in time. Apparatus and computer program products are also disclosed. An additional method is disclosed for providing coexistence of two time-division systems.

### TECHNICAL FIELD

This invention relates generally to wireless networks and, more specifically, relates to time division duplexing (TDD) systems.

### BACKGROUND

The third generation partnership project (3GPP) is working on adapting current implementations of code division multiple access (CDMA), such as wideband CDMA (W-CDMA) and multi-carrier CDMA (MC-CDMA), to achieve potentially much higher data rates than the theoretical 14.4 Mbps (megabits per second) under current adaptations of high speed packet access (HSPA). These efforts are commonly termed universal mobile telecommunications system (UMTS) terrestrial radio access node long term evolution (UTRAN LTE, or LTE for short), 3.99G, or Evolved UMTS.

Such LTE systems implement time division duplexing (TDD) and will have a number of benefits relative to current systems. When an operator deploys an LTE TDD system, it is rather likely that part of the available spectrum has already been occupied by an existing TDD system, and the resource usage of the existing system is not uniform cross the network. What this means is that the amount of occupancy for the time or frequency domains vary across the network. This requires the new system to have a very flexible structure in its channel and duplex (or single) frame design, so that the new system can be configured to fit into the radio resource resolution of the existing TDD system, which is normally described by its duplex spacing, time-slot, and radio frame structure.

For example, an operator may have already deployed an 802.16e system. The “802.16e” refers to a standard that includes an amendment to the institute for electrical and electronics engineers (IEEE) Standard for Local and Metropolitan Area Networks Part 16: Air Interface for Fixed and Mobile Broadband Wireless Access Systems Amendment for Physical and Medium Access Control Layers for Combined Fixed and Mobile Operation in Licensed Bands. The standard 802.16e was approved on 7 Dec. 2005 and was published on 28 Feb. 2006. Assume that the 802.16e system is running at a duplex frame configuration of 5 ms (milliseconds), such as 1 ms uplink and 4 ms downlink. Three 5 MHz (megahertz) carriers are occupied to reach re-use of three, and the operator only has a 15 MHz bandwidth in that area. It is highly desirable that LTE coverage can be introduced by sharing the 15 MHz spectrum in the time domain with the existing system.

Another example is an operator that has deployed a high chip rate TDD (HCR-TDD) in a bandwidth of 5 MHz and the operator would like to deploy 10 MHz LTE coverage over part of the network that overlaps with the existing 5 MHz. The LTE coverage now needs to share the spectrum with the existing 5 MHz TDD, and the frame structure of a corresponding LTE system must be configured in such a way that the frame structure fits into the 10 ms radio frame of the existing HCR-TDD.

It would therefore be desirable to provide methods for designing TDD systems such as LTE systems that allow the designed systems to coexist with currently existing TDD systems.

Furthermore, as LTE systems are implemented, it is expected that existing systems or portions thereof will be phased out. There should therefore be methods and corresponding systems that allow such LTE systems to be dynamically updated as existing systems are phased out.

### BRIEF SUMMARY

In an exemplary embodiment, a method includes communicating a number of first frames using a first communication scheme. Each of the first frames has one or more first active time periods. Communication of the first frames uses a first frequency band. The method includes communicating a number of second frames using a second communication scheme. Each of the second frames has one or more second active time periods. Communication of the second frames uses a second frequency band that at least partially overlaps the first frequency band. The communication of the first frames and communication of the second frames operate so that at least a portion of the first and second frames overlap in time but the first and second active time periods do not overlap in time.

In another exemplary embodiment, an apparatus is disclosed that includes one or more transceivers and one or more controllers coupled to the one or more transceivers. The one or more controllers are configured to cause communication through the one or more transceivers of a plurality of first frames using a first communication scheme. Each of the first frames has at least one first active time period. Communication of the first frames uses a first frequency band. The one or more controllers are further configured to cause communication through the at least one transceiver of a plurality of second frames using a second communication scheme. Each of the second frames has at least one second active time period. Communication of the second frames uses a second frequency band that at least partially overlaps the first frequency band. The communication of the first frames and communication of the second frames operate so that at least a portion of the first and second frames overlap in time but the first and second active time periods do not overlap in time.

In another exemplary embodiment, a computer program product is disclosed that tangibly embodies a program of machine-readable instructions executable by a digital processing apparatus to perform operations. The operations include causing communication of a number of first frames using a first communication scheme. Each of the first frames has at least one first active time period. Communication of the first frames uses a first frequency band. The operations include causing communication of a number of second frames using a second communication scheme. Each of the second frames has at least one second active time period. Communication of the second frames uses a second frequency band that at least partially overlaps the first frequency band. The communication of the first frames and communication of the second frames operate so that at least a portion of the first and second frames overlap in time but the first and second active time periods do not overlap in time.

In a further exemplary embodiment, a method includes, using a frame structure of a first time-division duplexing system, selecting a suitable time-domain resource unit (TDRU) and configuring a frame structure of a second time-division duplexing system such that mandated physical channels fit into a minimum time period T0, and T0 occupies one or more TDRU. The method includes time-division duplexing system and that comprises at least one TDRU, and operating the first and second time-division duplexing systems.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is a diagram of compatible frame structure for time-division CDMA (TD-CDMA) and LTE;

FIG. 2 is an example of spectrum coexistence for World Interoperability for Microwave Access (Wimax) and LTE;

FIG. 3 is a simplified block diagram of an exemplary system suitable for implementing aspects of the disclosed invention;

FIG. 4 is a flowchart of an exemplary method providing flexible radio resource sharing in time and/or frequency domains among TDD communication systems;

FIG. 5 is a flowchart of an exemplary method for designing radio frame and physical channel structure of an LTE system to enable time domain dynamic sharing of radio resources;

FIG. 6 is a flowchart of an exemplary method for configuring a wireless network or portion thereof to provide time domain dynamic sharing of radio resources;

FIG. 7 is a flowchart of an exemplary method for dynamically modifying resource split between existing and new TDD systems;

FIG. 8 is a figure illustrated the variable duplex property of a first, generic TDD;

FIG. 9 is a figure illustrating a scenario allowing coexistence using the same carrier for existing and new TDD systems;

FIG. 10 is a figure illustrating a high chip rate time-division duplex (HCR-TDD) frame;

FIGS. 11-13 are figures illustrating possible configurations for radio resource sharing between HCR-TDD and the first, generic TDD;

FIG. 14 is a figure illustrating a possible frame configuration for HCR-TDD and the first, generic TDD in order to coexist in the same network;

FIG. 15 is a diagram illustrating low chip rate TDD (LCR-TDD) radio frames and sub-frames;

FIGS. 16-18 are figures illustrating possible configurations for radio resource sharing between LCR-TDD and a second TDD;

FIG. 19 is a figure illustrating a possible frame configuration for LCR-TDD and the second TDD in order to coexist in the same network;

FIG. 20 is a figure illustrating a frame for 802.16e (Wimax);

FIG. 21 is a figure illustrating signaling of frame information to a user equipment using Wimax;

FIG. 22 is a figure illustrating an example of how Wimax and TDD can coexist on the same carrier; and

FIG. 23 is a simplified block diagram of a portion of an apparatus suitable for carrying out exemplary embodiments of the disclosed invention.

### DETAILED DESCRIPTION OF EXEMPLARY EMBODIMENTS

As previously described, it can be problematic when a new TDD system is introduced into a wireless network that already contains another TDD system. On the other hand, the principle of allowing coexistence of TDD systems in time and frequency domains is well known, and this is commonly understood as one of the inherent flexibilities of a TDD system. For example, IPWireless has promoted coexistence of LTE-TDD and HCR-TDD, and companies have promoted the coexistence of LTE-TDD with Wimax.

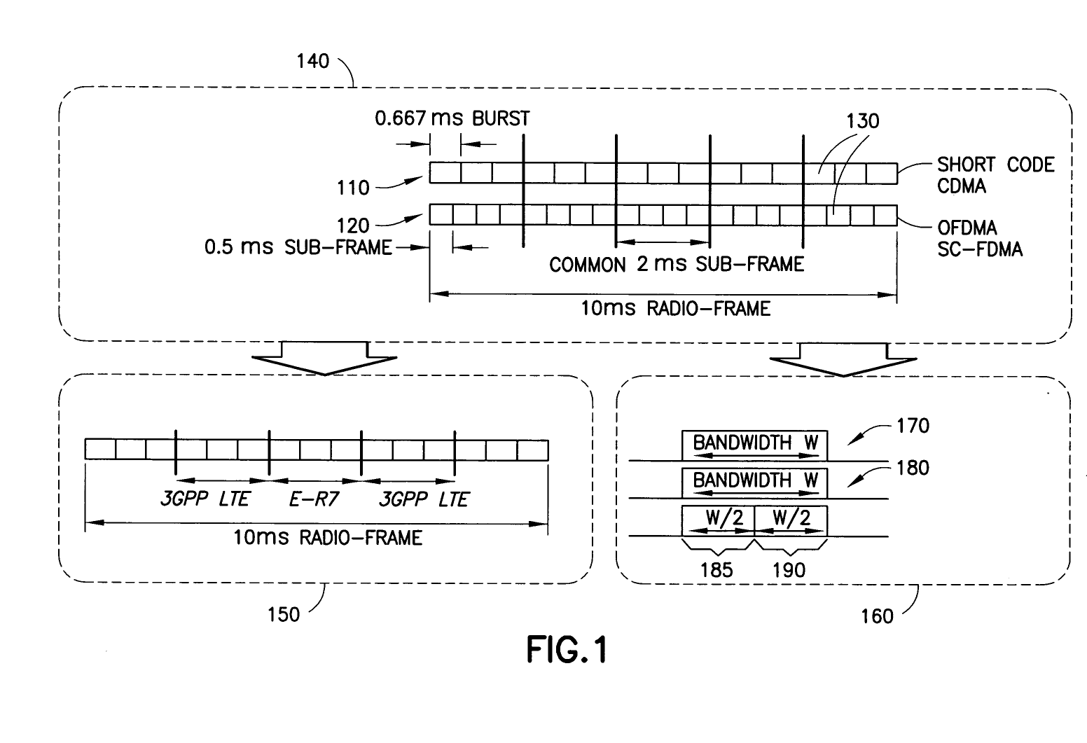

For instance, FIG. 1 is a diagram of compatible frame structure for time-division CDMA (TD-CDMA) and LTE. Reference 140 shows common frame structure for the radio frame 110 for TD-CDMA (called “E-R7”) and for the radio frame 120 for LTE. Both radio frames 110, 120 have 10 ms frames, with 2 ms sub-frames. Each 2 ms sub-frame accommodates 2 times 1 ms LTE bursts (e.g., or possible 4 times 0.5 ms bursts), or 3 times 0.667 ms TD-CDMA bursts. Reference 130 is used to indicate that both TD-CDMA and LTE utilize self-contained transmissions. Reference 130 shows an example of time division sharing between LTE and E-R7 (TD-CDMA). Reference 160 shows how the bandwidth W 170 for TD-CDMA and the bandwidth W 180 for LTE can be shared by halving the bandwidths to bandwidth W/2 185 for TD-CDMA and bandwidth W/2 190 for LTE.

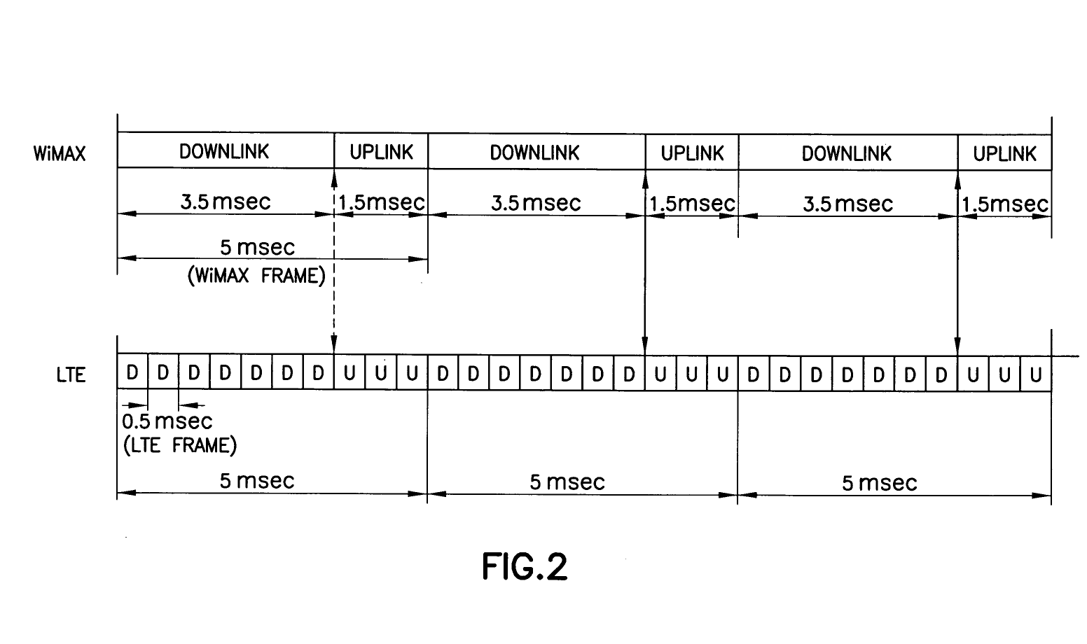

FIG. 2 is an example of spectrum coexistence for World Interoperability for Microwave Access (Wimax) and LTE. In this example, uplink and downlink time periods are synchronized to avoid interference. In a TDD system, one cause of severe interference comes from the user equipment (UE) to UE interference and base station (BS) to BS interference due to non-synchronized uplink and downlink transmissions in same carrier/frequency. To avoid such interference, the network needs to perfectly synchronize and align the uplink and downlink transmissions among different BSs and UEs. In another words, all UE/BS should transmit/receive at same time.

However, a system design that enables dynamic radio resource sharing in time and frequency domains cross a network has not been addressed. Since an operator (e.g., owner or part owner of the network) is likely to need to reserve different amount of resources for the existing terminal base and the new terminal base cross the network, as well as over the period of migration, dynamic resource sharing among the existing and new TDD systems is highly desirable. Furthermore, also the supported granularity (e.g., in terms of time periods) should be sufficiently small.

Here, by dynamic resource sharing, it is meant, e.g., that, during the time period when the existing and new systems coexist over the same frequency spectrum, the radio resource occupied by each system can be modified while the network is operational (e.g., supporting on-going UE calls). The modification may take place at different parts of the network at the same time (e.g., cell by cell or area by area), and/or at different times (e.g., over days or hours).

Exemplary embodiments of the disclosed invention relate to the deployment of a new advanced TDD communication system (e.g., LTE) in the overlapping spectrum and time domain with some existing TDD systems. The new advanced system is designed to have a variable channel bandwidth and frame structure property, in such a way that it enables easy coexistence and radio resource sharing of the new system with the existing systems that are already in the field.

More specifically, exemplary embodiments of this invention relate to the design of LTE TDD modes in terms of duplex frame structure (e.g., uplink and downlink), which allows flexible sharing of radio resource in time and frequency domains with the existing TDD communication systems, such as 3GPP LCR-TDD, HCR-TDD, and 802.16e. Both LCR-TDD and HCR-TDD utilize the communication scheme of time-division and spread spectrum code-division multiple access techniques, and 802.16e utilizes the communication scheme of orthogonal frequency division multiple access (OFDMA). LTE-TDD utilizes the communication schemes of OFDMA in downlink and single carrier FDMA in the uplink. A communication scheme may therefore be defined, e.g., by one or more of multiplexing techniques (e.g., CDMA), modulation techniques, and other information. It is also noted that exemplary embodiments of the disclosed invention may also use a single frame structure (e.g., downlink only).

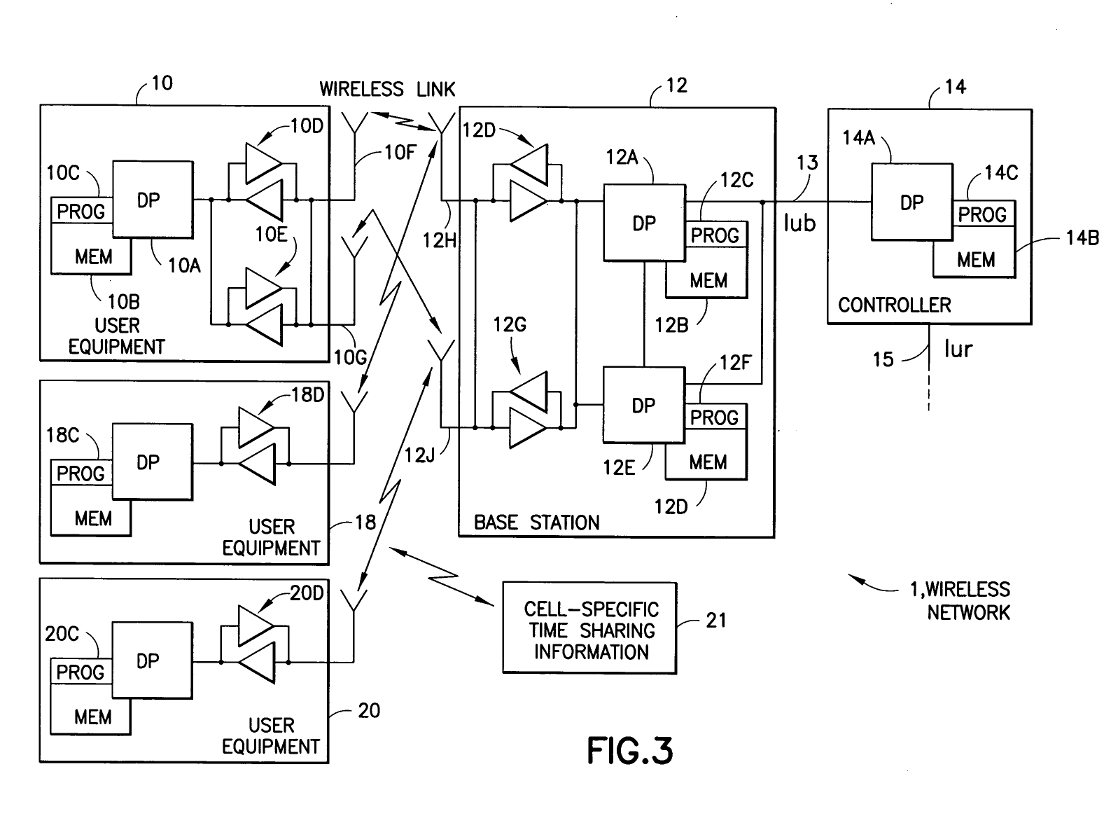

FIG. 3 is an exemplary system containing devices suitable for implementing aspects of the disclosed invention. In FIG. 3, a wireless network 1 is adapted to include communication between a multimode UE 10, a “legacy” UE 18, and a “new” UE 20 and a base station (e.g., Node B, evolved Node B, or BTS) 12 via a wireless link. The multimode UE 10 supports the “existing” and “new” TDD schemes and corresponding systems, while the legacy UE 18 supports only the existing TDD scheme and corresponding system and the new UE 18 supports only the new TDD scheme and corresponding system. The network 1 may also include a network controller (e.g., RNC) 14, which may be referred to as, e.g., a serving RNC (SRNC). The multimode UE 10 includes a data processor (DP) 10A, a memory (MEM) 10B that stores a program (PROG) 10C, and a suitable radio frequency (RF) transceiver 10D for bidirectional wireless communications with the transceiver 12D of base station 12. The multimode UE 10 also includes an RF transceiver 10E for bidirectional wireless communications with the transceiver 12G of base station 12. The multimode UE 10 includes or is coupled to an antenna 10F and includes or is coupled to antenna 10G. The base station 12 includes a DP 12A, a-MEM 12B that stores a PROG 12C, and RF transceivers 12D, 12G. The base station 12 may also include a DP 12E, MEM 12D, and PROG 12F. The base station 12 is coupled to or includes antenna 12H. The base station 12 may optionally be coupled to or include antenna 12J.

The base station 12 is coupled via a data path 13 (Iub) to the network controller 14 that also includes a DP 14A and a MEM 14B storing an associated PROG 14C. The network controller 14 may be coupled to another network controller (e.g., another RNC) (not shown) by another data path 15 (Iur).

Two other single mode UEs 18 and 20 are shown. UE 18 includes a data processor (DP) 18A, a memory (MEM) 18B that stores a program (PROG) 18C, and a suitable radio frequency (RF) transceiver 18D for bidirectional wireless communications with the transceiver 12D of base station 12. Assuming that the transceiver 12D supports an existing, legacy TDD scheme, the UE 18 is a legacy UE. The UE 18 includes or is coupled to antenna 18F. The UE 18 includes or is coupled to antenna 18F. UE 20 includes a data processor (DP) 20A, a memory (MEM) 20B that stores a program (PROG) 20C, and a suitable radio frequency (RF) transceiver 20D for bidirectional wireless communications with the transceiver 12D of base station 12. Assuming that the transceiver 12E supports a new TDD scheme, the UE 20 is a UE that only supports the new TDD scheme and does not support the legacy TDD scheme. The UE 20 includes or is coupled to antenna 20F.

The PROGs 10C, 12C, 18C, and 20C (and possibly 12F) are assumed to include program instructions that, when executed by the associated DP, enable the electronic device to operate in accordance with the exemplary embodiments of this invention, as will be discussed below in greater detail.

In an exemplary embodiment, an “existing” TDD communication system includes the UEs 10 and 18 including the transceivers 10D and 18D and antennas 10F and 18F and the base station 12 including the antenna 12H and the transceiver 12D, along with appropriate control (e.g., a scheduler/controller) in PROG 10C, 18C, and 12C. A “new” TDD communication system is added to wireless network 1 by including the transceivers 10E and 20E in the UEs 10 and 20 and the transceiver 12G, along with appropriate control (e.g., a scheduler/controller) in PROG 10C, 20C, and 12C. It is also possible for a new DP 12E and associated PROG 12F and MEM 12D to be added to include new functionality associated with the new TDD communication system. Additionally, one or both of new antennas 10G, 12J may also be used. Further, transceivers 10D, 12D may be modified to support the new TDD communication system and therefore transceivers 10E and 12G would not be used. It is noted that, as described in more detail below, the frames for the new and existing TDD system share time domain resources. Such sharing ensures that active periods (e.g., periods assigned to a UE 10, 18, 20 or base station 12 for uplink or downlink) of the frames of the two different TDD systems do not overlap in time. In some exemplary implementations herein, information related to time periods allotted for the two different TDD systems may be communicated from the base station 12 to the UE 10, 18, 20. For instance, cell specific time sharing information 21 may be communicated from the base station 12 to the UE 10, 18, 20.

In general, the various embodiments of the UEs 10, 18, 20 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software (e.g., in PROG 10C, 12C, 18C, 20C and possibly 12F if used) executable by the DP 10A, 12A, 18A, and 20A (and possibly 12E), or by hardware, or by a combination of software and hardware. The MEMs 10B, 12B, 18B, 20B, and 14B (and possibly 12D) may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A, 18A, 20A, and 14A (and 12A if used) may be of any type suitable to the local technical environment, and may include one or more of general purpose computers, special purpose computers, microprocessors, digital signal processors (DSPs) and processors based on a multi-core processor architecture, as non-limiting examples. Exemplary embodiments of the disclosed invention also include a computer program product tangibly embodying a program of machine-readable instructions executable by a digital processing apparatus such as UEs 10, 18, 20 or base station 12 to perform operation described herein.

The disclosed invention includes, in exemplary embodiments, the following two aspects (a) and (b) that are used to enable dynamic resource sharing between, e.g., an LTE TDD system and existing TDD systems. In general terms, the aspect (a) is directed to how the LTE TDD system should be designed to enable the LTE TDD system to fit into the legacy (e.g., “existing”) TDD system by sharing part of the time/frequency resources with the legacy TDD system, whereas aspect (b) describes how to design a network to incorporate the designed LTE TDD system to cause dynamic time/frequency sharing between the LTE TDD system and the existing TDD system.

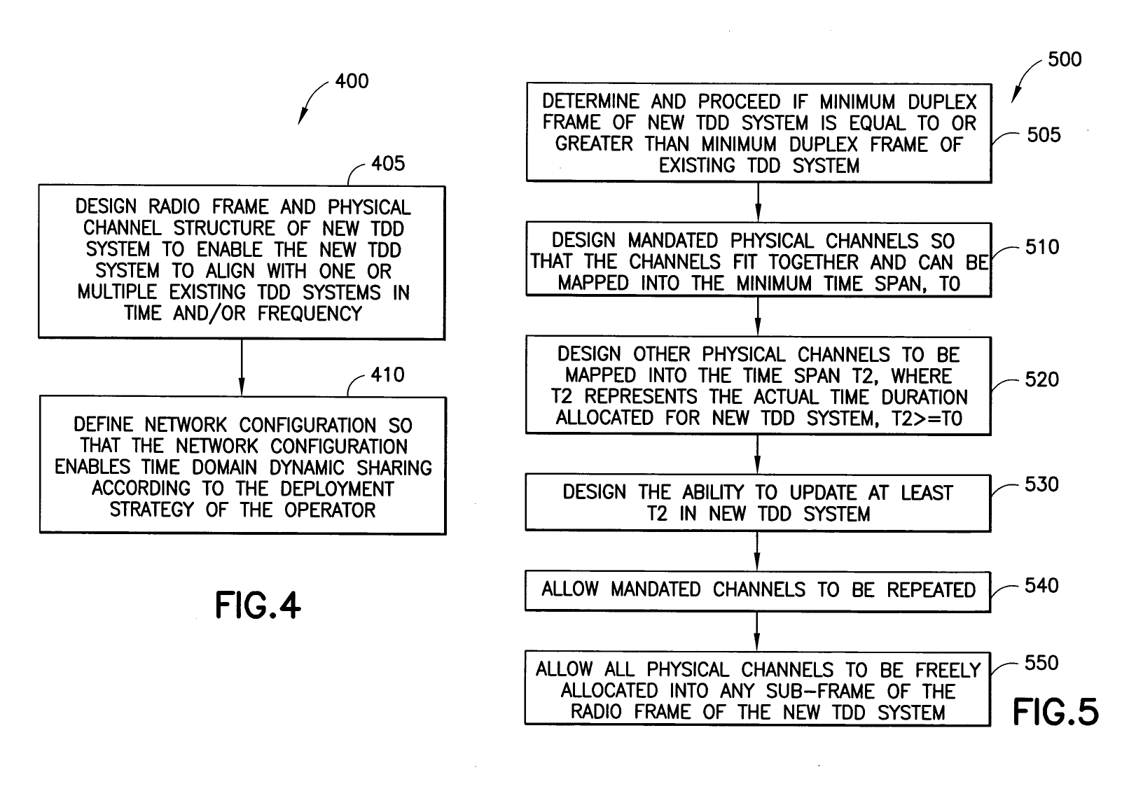

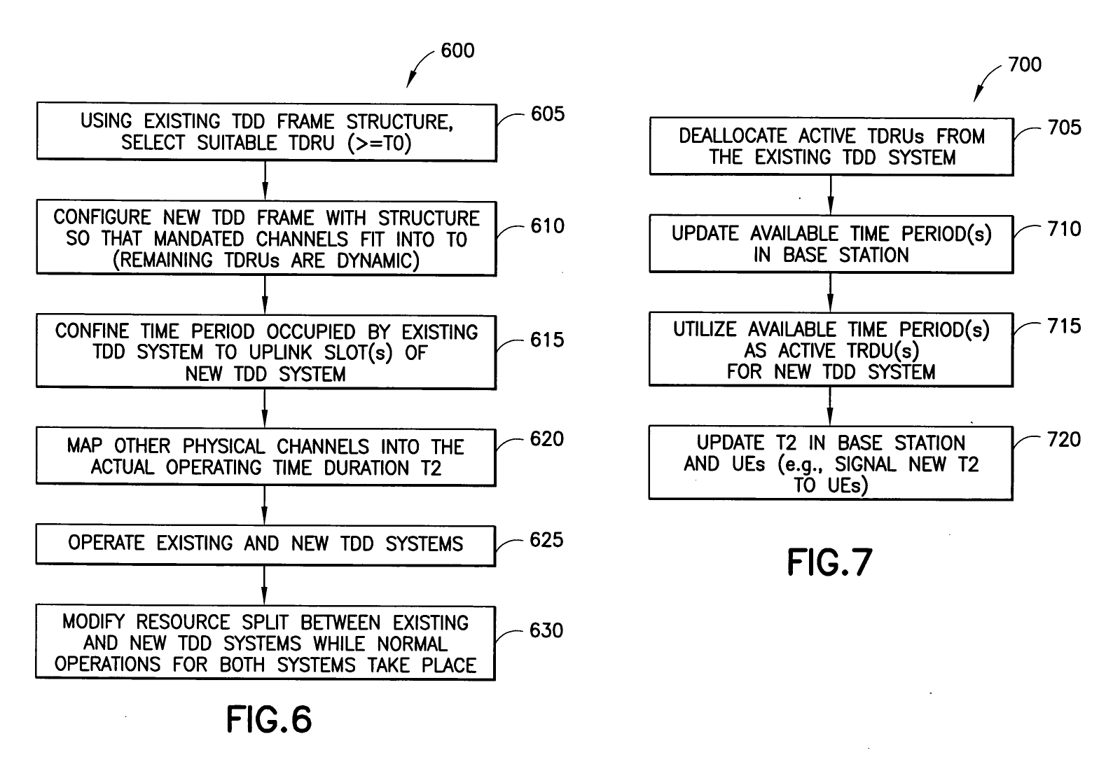

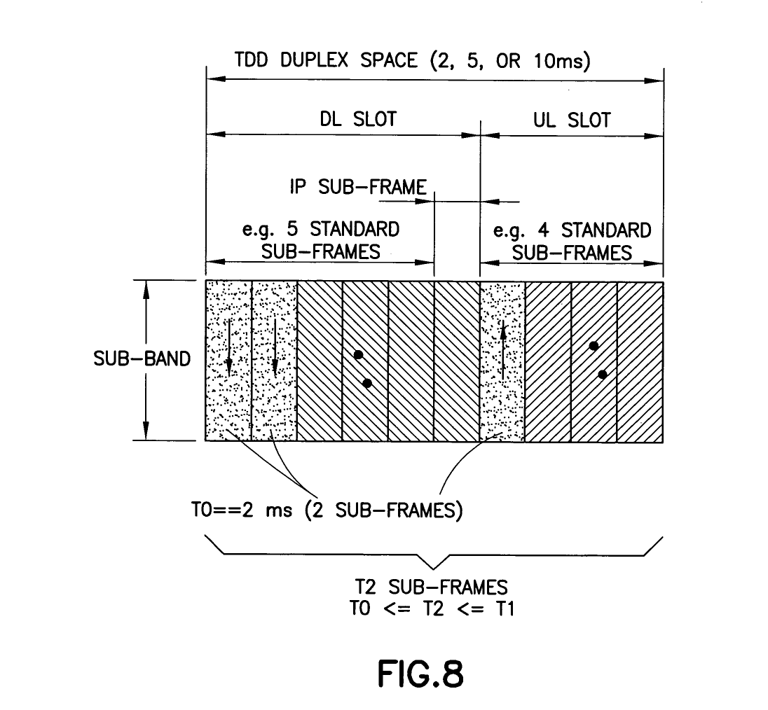

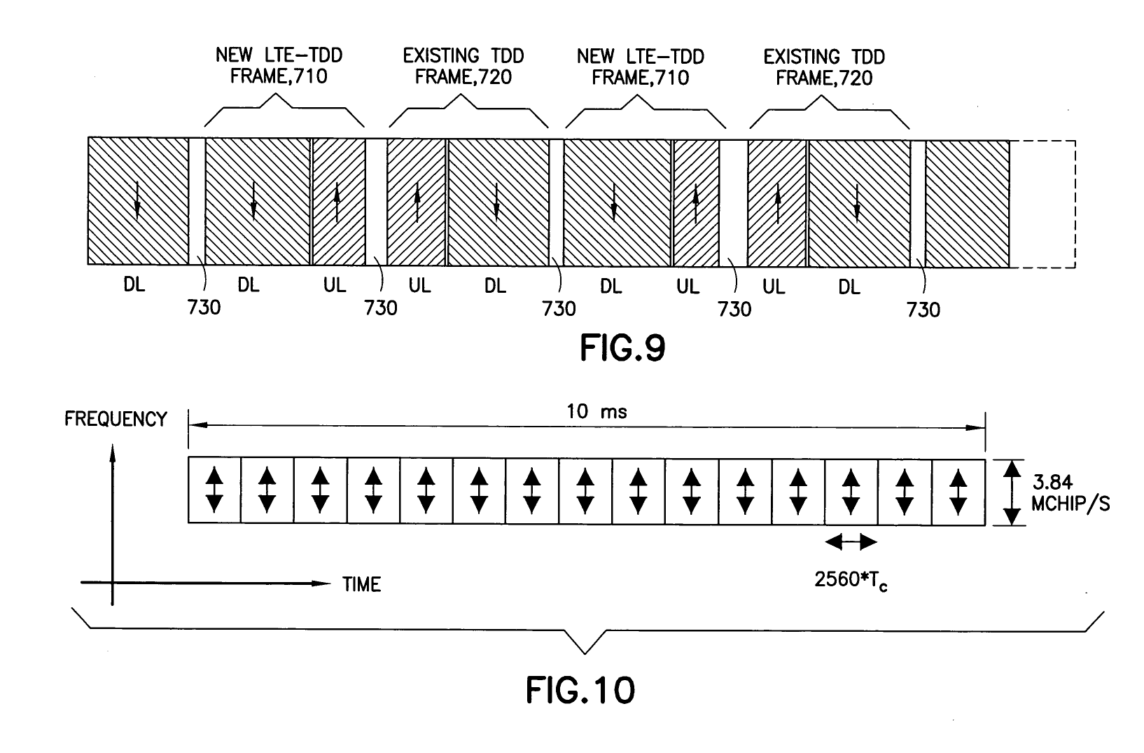

Consequently, turning to FIG. 4, in block 405 of method 400, the radio frame and physical channel structure of an LTE system is designed to enable LTE to align with one or multiple existing TDD systems in time and/or frequency. Block 405 represents aspect (a), and is described in more detail in FIG. 5. In block 410, the network configuration is designed so that the network configuration enables time domain dynamic sharing according to the deployment strategy of the operator. Block 410 represents aspect (b), and is described in more detail in reference to FIGS. 6 and 7. It is noted that emphasis is placed herein on LTE TDD systems, but the disclosed invention is applicable to other TDD systems.

(a) The radio frame and physical channel structure of an LTE system is designed in order to enable LTE to align with one or multiple existing TDD systems in time and frequency domains in the granularity of one or more timeslots, and one or more channel spacings of the existing systems. See block 405 of FIG. 4. More specifically, the frame structure is designed to contain the following properties (reference may be had to method 500 of FIG. 5):

(a)(1) The minimum duplex frame in LTE that is supported is significantly smaller than the legacy systems with which LTE intends to coexist. For example, LTE supports 2 ms, which would mean that LTE could be introduced to the network with the minimum operating duration T0 of 2 ms. Meanwhile, typical existing TDD systems normally run at 5 ms or 10 ms frame basis. Consequently, in block 505, it is determined and a decision is made to proceed if the minimum duplex frame of the new TDD system is equal to or greater than the minimum duplex frame of the existing TDD system.

(a)(2) The mandated physical channels that are essential for maintaining the network operation, such as common control channels, should be designed (block 510) such that the channels fit together and can be mapped (block 510) into the minimum time span T0. Exemplary common control channels include SCH (synchronization control channel), BCH (broadcast channel), cell specific reference signals (RS) sequence, and RACH (random access channel).

(a)(3) The other physical channels are designed (block 520) to be mapped into the time span T2, where T2 represents the actual time duration allocated for LTE, T2>=T0 but is less than T1 (when coexistence occurs, that is). T2 reaches the maximum value (which is system dependent) when 100 percent time occupancy has been reached for LTE on that frequency carrier.

(a)(4) Depending on the network configuration, the actual operating time duration T2 for LTE/TDD may designed (block 530) to be signaled (e.g., using the cell-specific time sharing information 21) explicitly to all the UEs connected to the cell. In some configurations, explicit signaling is not needed, and T2 is just dynamically updated (block 530) in the eNode B (evolved Node B) scheduler (e.g., as part of PROG 12C or 12F).

(a)(5) Some of the mandated channels will be repeated more often, such as SCH, and cell specific RS sequence, if the allocated time domain resource to LTE allows. This occurs in block 540. This is to enhance the mobility performance, wherever possible. However, the repetition is not mandated since the network can function in the minimum span mode. In other words, certain channels are mandated anyway, e.g., at least one occurrence per 10 ms (for instance). However, more occurrences per 10 ms might be beneficial to other performance requirements, e.g., mobility, but it is up to the operator to decide how many occurrences should be performed to achieve certain designed target. Nonetheless, one occurrence per frame is the minimum occurrence for certain channels, and these channels are therefore considered to be mandated.

(a)(6) Furthermore, all physical channels can be freely allocated (block 550) into any sub-frame of the LTE radio frame, in order to allow LTE to be deployed into any part of the TDD frame of the existing TDD system.

(b) The network configuration may be defined in a way such that the network configuration enables time domain dynamic sharing according to the deployment strategy of the operator. This occurs in block 410 of FIG. 4. More specifically, the network configuration should contain the following properties (see FIG. 6, which is a flowchart of an exemplary method 600 for configuring a wireless network or portion thereof to enable time domain dynamic sharing of radio resources):

(b)(1) From the existing TDD duplex frame structure, a suitable time-domain resource unit (TDRU) is selected to plan re-farming (e.g., reallocation). The selected TDRU should be greater than or equal to the LTE minimum operating time duration, T0. This occurs in block 605.

(b)(2) Configure the new LTE/TDD frame with a structure such that the mandated channels of the LTE fit into the minimum span T0 (e.g., a minimum time period). At this phase of network configurations one TDRU is statically allocated to LTE, and the remaining TDRUs are designated as “dynamic”, i.e., they can be freely allocated between the existing TDD configuration and new LTE-TDD configuration. This occurs in block 610.

(b)(3) It is desirable that the time period occupied by the legacy TDD system should be confined to the uplink slot (e.g., one or more TRDUs) of the LTE frame, if possible. This occurs in block 615. Thus, in uplink, eNode B (e.g., base station 12) can ensure those uplink timeslots (e.g., one or more TRDUs) of the LTE are kept free by simply not allocating them to any LTE UE.

(b)(4) The other physical channels are mapped (block 620) into the actual operating time duration T2. T2 is the planned time domain resource for LTE at the start of re-farming process, and T2 is equal to one or more TDRUs (time domain resource units). The remaining TDRUs are what can be used for the existing TDD. The value of T2 from cell to cell can be set differently according to the capacity needed for LTE in particular cells. It is noted that in block 625, the existing and new TDD systems are operated.

(b)(5) During the life time of re-farming (e.g., reallocation), there may be a need to modify the resource split (block 630) between the two TDD systems. It is noted that this modification occurs during normal operations for the two TDD systems (e.g., the “existing” and “new” TDD systems). Reference may also be had to FIG. 7, which shows a flowchart of an exemplary method 700 for dynamically modifying resource split between two TDD systems. To move the dynamic resource towards the “new” LTE system, the network 1 (e.g., the base station 12) should first de-allocate one or more active TDRU(s) from the available time periods (e.g., timeslots or sub-frames) for traffic from the “existing” TDD system. This occurs in block 705. The network 1 (e.g., the base station 12) then updates (block 710) the available time periods (e.g., timeslots or sub-frames) accordingly in, e.g., the LTE Node B scheduler (e.g., as part of PROG 12C and/or 12F) which will then start to utilize (block 715) the additional resource(s) in scheduling. In other words, the Node B scheduler will activate the TDRUs for the new TDD system. If needed, the new value of T2 (for the new. TDD system) will be sent/signaled (block 720) (e.g., using the cell-specific time sharing information 21) to UEs in the LTE cell to reflect the change. Note that the BCH, for instance, may be used to signal the cell specific system information (e.g., using the cell-specific time sharing information 21). All these operations take place without having to interrupt the normal cell operation of both TDD systems.

An issue when running a dynamic resource sharing network as in the above example is to ensure consistent behavior from the terminals of both TDD systems. This means each system must be defined with a fixed configuration in part of the frame structure (non-overlapping with the other system), while the remaining timeslots can be dynamically utilized by one system or the other across the network, depending on the resource need for each system. These timeslots (e.g., radio capacity) carry scheduled data traffic only, so that the timeslots can be: de-allocated and released for the other system to use, as needed. The basic operation of the system in that cell is not affected.

In a normal case, the resource sharing can change from cell to cell, but the system does not prevent dynamic sharing within one cell area. This implementation requires an interface between the two systems to exchange capacity information. For example, upon request, LTE-TDD may start to free one or more timeslots by allocating PRBs (physical resource block of LTE) limited to the remaining timeslots, from the following radio frame. This would release the capacity to LCR-TDD immediately, while continuing to serve the users.

Now that exemplary techniques of the disclosed invention have been described, some examples of using the techniques to create suitable networks will be given. One of the suitable TDD configurations (as stated above) useful for flexible radio resource sharing among TDD systems is LTE. One of the main advantages of LTE TDD is its flexibility in the duplex frame structure, allowing network to run in different ways in different timeslots. LTE has the following benefits: it supports variable duplex space; it supports spectral sharing among multiple TDD systems; it enables step by step migration from the existing TDD configuration to a new LTE-TDD configuration that coexists with the existing TDD configuration; and it provides radio resources that can be shared in time and/or frequency domains.

Exemplary embodiments described herein include the following: A first TDD frame structure, and possible system configuration so a new TDD with the first frame structure can be added to and coexist with HCR-TDD (the existing TDD); and an LCR-TDD compatible frame structure, and possible system configuration so that a second TDD with a second frame structure that can be added to and coexist with LCR-TDD (the existing TDD). Furthermore, another new TDD can be utilized to allow coexistence with 802.16e (Mobile Wimax system profile) on the same carrier.

With regard to LTE-TDD, the first TDD can be considered a “generic” TDD that can be developed in 3GPP and is a version of LTE. This “generic” TDD has been designed to operate with multiple duplex spaces: 10 ms, 5 ms, 2 ms, with minimum DL (downlink)/UL (uplink) split resolution of one sub-frame (1 ms). An exemplary aim herein is to enable coexistence with multiple existing TDD systems in the field, and implement gradual migration to the new system over the same frequency band as the existing TDD system. In order to be 100 percent frame-wise compatible with LCR-TDD, an alternative TDD has also been proposed in 3GPP. This second TDD has a fixed duplex space of 5 ms, as in LCR-TDD. It is expected both the first, generic TDD and the second TDD will be part of the LTE specification, and possibly other TDDs will also be part of the LTE specification.

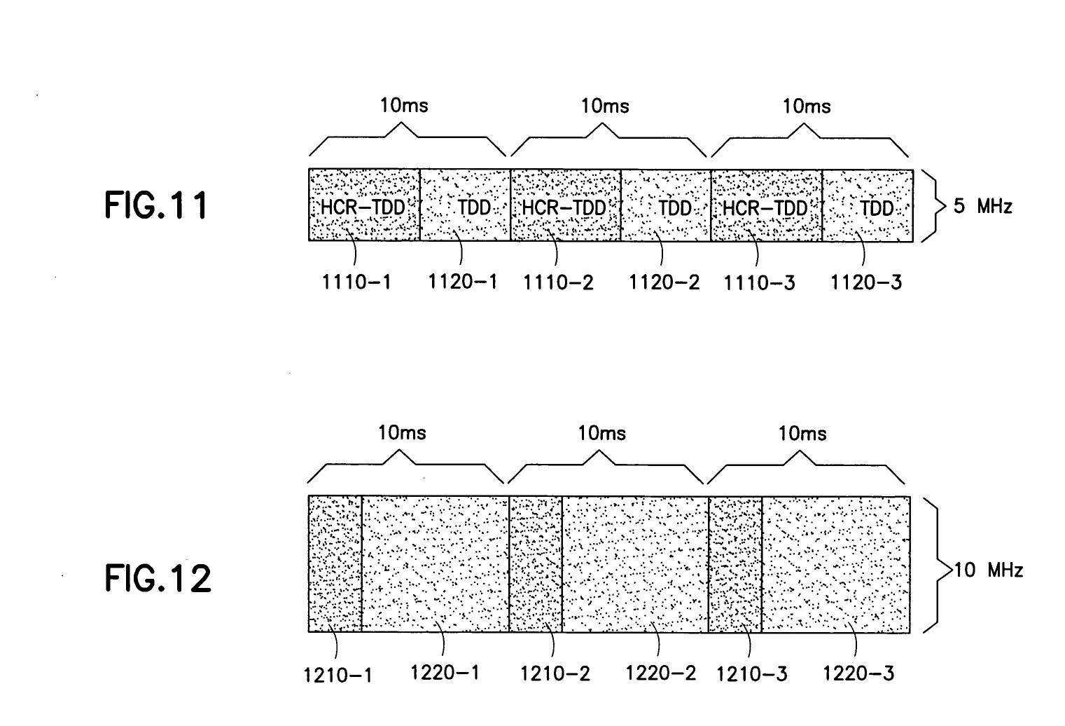

Referring now to FIG. 8, a figure is shown illustrating the variable duplex property of the first, generic TDD. The first, generic TDD is a scalable duplex spacing system having the following properties: minimum operating duration, T0, is 2 ms (1 DL sub-frame with 1 UL sub-frame, which is equivalent to 20 percent occupancy); maximum operating duration, T1, is 10 ms (or 20 sub-frames), which is equivalent to 100 percent occupancy; and the first, generic TDD operates in steps of one sub-frame.

Further, the duplex frame structure repeats every 10 ms radio frame. Common channels, SCH, BCH, RS (with Cell ID), and RACH, are mapped to the minimum duration T0. Other channels may occupy a portion or all of a longer duration T2, where T0<=T2<=T1. T2 represents the actual time duration allocated for the first, generic TDD. The value of T2 may be explicitly indicated (see block 520 of FIG. 7) to UE 10 on, e.g., BCH (e.g., over the wireless link), or the value of T2 may be changed dynamically in the eNode B scheduler.

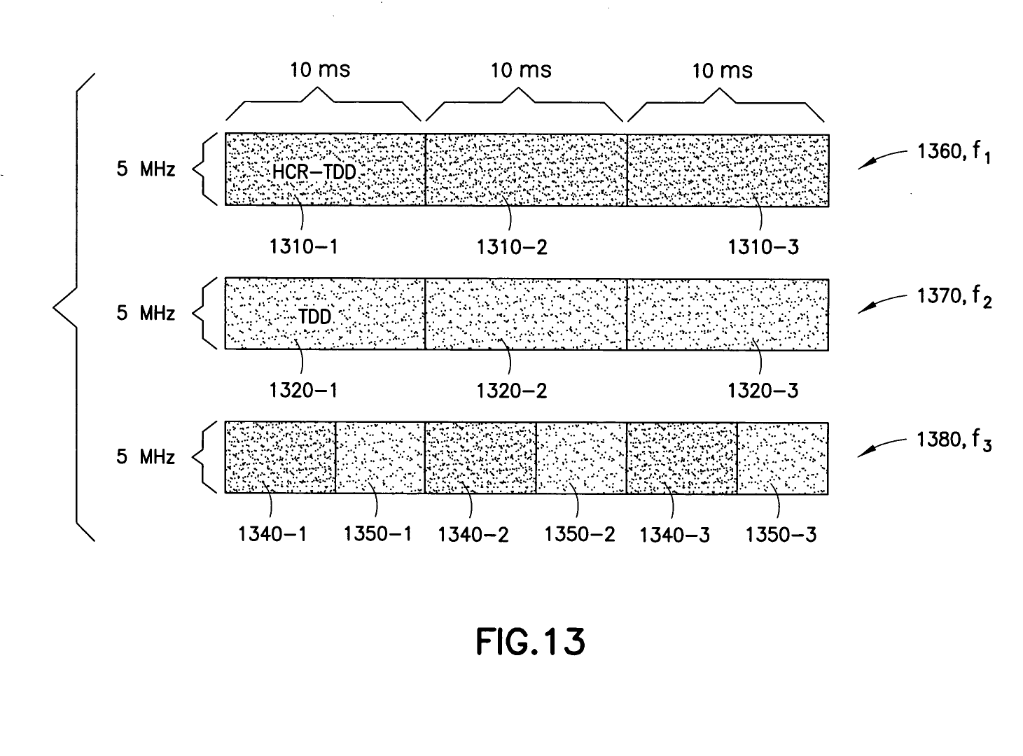

Turning to FIG. 9, a figure is shown illustrating a potential scenario allowing coexistence using the same carrier for existing and new TDD systems. Coexistence is shown for 10 MHz LTE-TDD and existing TDD. LTE-TDD is introduced in the same carrier i.e., 10 MHz) of the existing network. Both TDD systems must share the same duplex space. LTE-TDD frames 710 may not perfectly align with the frames 720 of the existing TDD system. Some idle periods 730 will be left since neither of the systems can utilize these periods 730 for transmission in downlink (DL) or uplink (UL). Thus, some occupancy efficiency is lost in the time domain, which means that placing the frames 710, 720 side-by-side (non-overlapping in time and separated in time by the idle periods 730) reduces efficiency.

By contrast, the inventors have realized that using the variable duplex space property, LTE can be introduced into this network with a minimum occupancy of 20 percent (2 ms), in the same frequency band as the existing TDD system. Consequently, instead of placing the frames 710, 720 side-by-side in a non-overlapping (in time) manner, the frames can overlap in time, as long as the active regions (one or both of uplink and downlink) for each of the frames from each of the TDD systems do not overlap in time. The resource allocated to LTE may be gradually increased to meet the re-farming (e.g., reallocation) need, until the full carrier is completely given to LTE (i.e., existing system 720 is removed from that carrier).

During the transition period, the operation of the LTE system is not interrupted because the duration T0 contains all the necessarily functionality to run the network. Furthermore, the UE can “camp” (e.g., stay assigned to LTE) in the cell as normal. Only the resource available for traffic varies. This means LTE and legacy TDD systems can share the remaining time duration (e.g., a resource) in different parts of the network, and during different phases of the migration process.

The resolution at which LTE may share in time domain with a legacy TDD system will depend on the time-slot solution of the legacy system. For HCR-TDD, resolution is 2 ms (three HCR timeslots). For LCR-TDD, resolution is 0.675 ms (one LCR timeslot). For 802.16e, resolution is 0.5 ms.

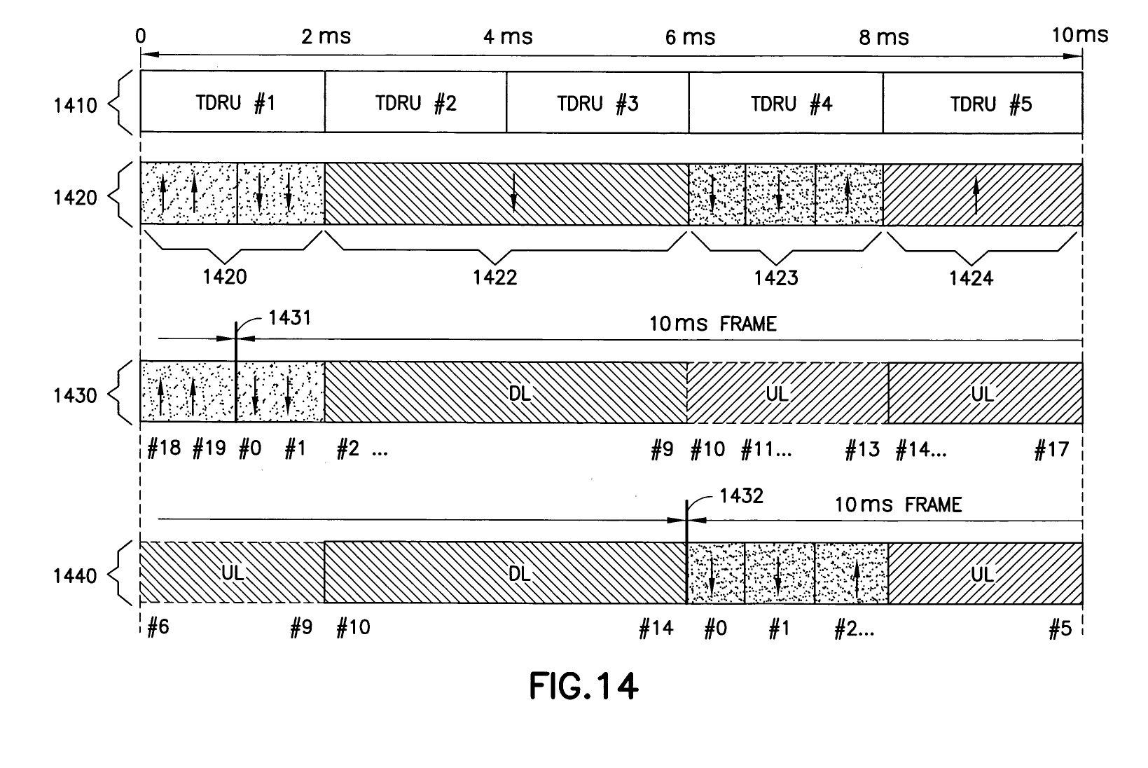

FIG. 10 is a figure illustrating an HCR-TDD frame. In HCR-TDD, 10 ms radio frame (which is equivalent to a TDD duplex space) is divided into 15 timeslots (each 0.667 ms, which is 2560T_{c}, which is the carrier period). HCR-TDD has two possible operating channel bandwidths, 5 MHz and 10 MHz, chip-rates of 3.84 Mcps (megachips' per second) and 7.68 Mcps, respectively. At a minimum, HCR-TDD needs two timeslots to operate (one timeslot DL with one timeslot UL).

To coexist with the first, generic TDD in time domain, a 10 ms radio frame resource can be divided into five by 2 ms time-domain resource units (TDRUs): 2 ms yields three HCR-TDD timeslots; and 2 ms yields four sub-frames of the first, generic TDD. HCR-TDD needs one TDRU (2 ms) to operate as minimum, e.g., two timeslots in DL and one timeslot in UL. The first, generic TDD needs one TDRU (2 ms) to operate as minimum, e.g., two sub-frames in DL and two sub-frames in UL. The remaining three TDRU (6 ms) can be shared between the two systems, in different parts of the network, and/or over different periods of time.

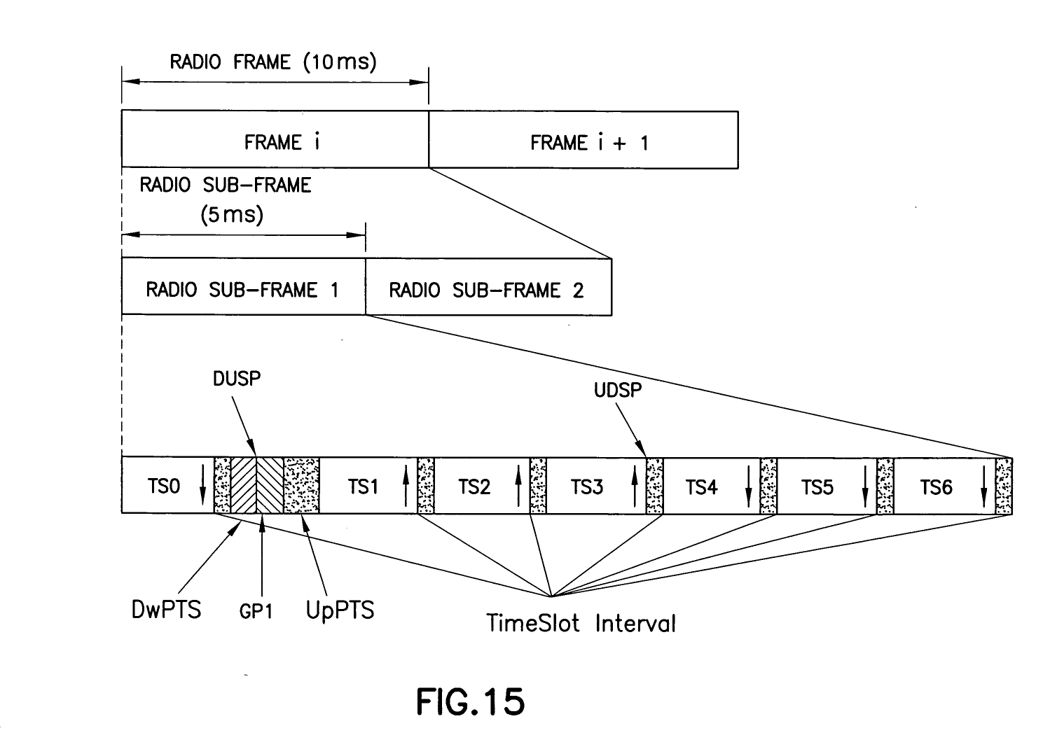

FIGS. 11-13 are figures illustrating possible configurations for radio resource sharing, according to the methods in FIGS. 4-7, between HCR-TDD and the first, generic TDD. FIG. 11 illustrates a cell with coexistence in 5 MHz TDD frequency band (e.g., a bandwidth of 5 MHz) with LTE occupancy of 40 percent. HCR-TDD operates in time periods 1110-1, 1110-2, and 1110-3 while the first, generic TDD operates in time periods 1120-1, 1120-2, and 1120-3. FIG. 12 illustrates a cell with coexistence in 10 MHz TDD frequency band (e.g., a bandwidth of 10 MHz) with LTE occupancy of 80 percent. HCR-TDD operates in time periods 1210-1, 1210-2, and 1210-3 while the first, generic TDD operates in time periods 1220-1, 1220-2, and 1220-3. FIGS. 11 and 12 are examples of sharing the resource of time. FIG. 13 illustrates a cell with coexistence in 15 MHz TDD band (split into three 5 MHz frequency bands 1360, 1370, and 1380, each with a different carrier frequency, f₁, f₂, and f₃, respectively) with LTE occupancy of 47 percent. HCR-TDD operates in time periods 1310-1, 1310-2, 1310-3, 1340-1, 1340-2, and 1340-3 while the first, generic TDD operates in time periods 1320-1, 1320-2, 1320-3, 1350-1, 1350-2, and 1350-3. It is noted that each of 1310-1, 1320-1 and (1340-1 plus 1350-1) is the same 10 ms time period. It is also noted that FIG. 13 is an example of sharing the resources of time and frequency.

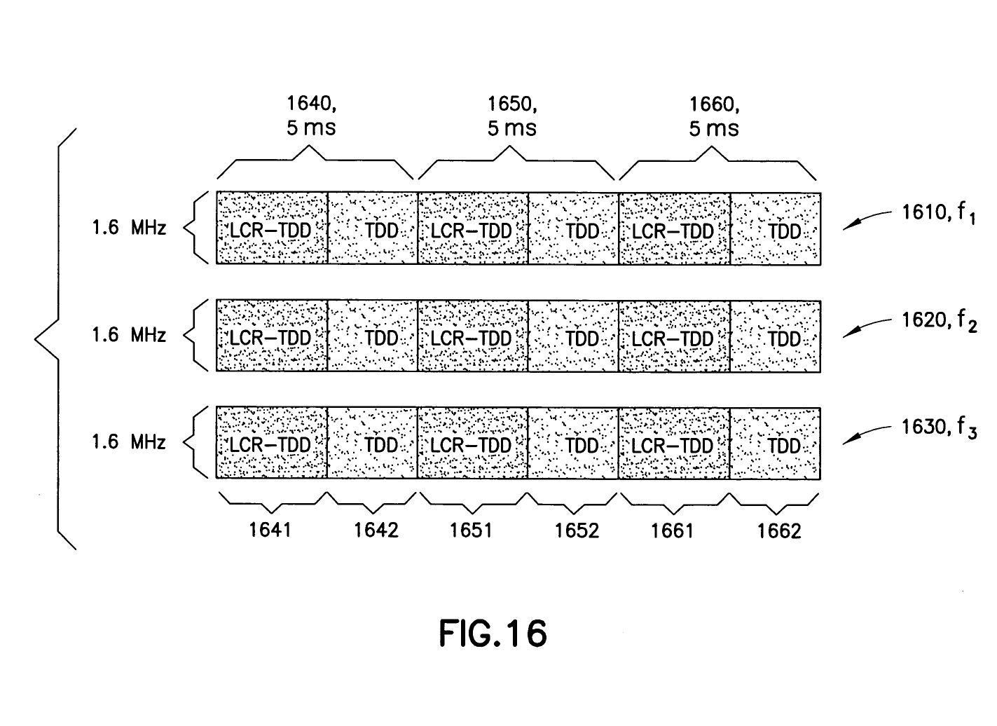

FIG. 14 is a figure illustrating a possible frame configuration for HCR-TDD and the first, generic TDD in order to coexist in the same network. The frame configuration 1410 indicates that there are five TDRUs to be used. The frame configuration 1420 indicates the following: time period 1421 (e.g., TDRU#1) is allocated to the first, generic TDD; time period 1422 (e.g., TDRU#2 and TDRU#3) is allocated for downlink for either the first, generic TDD or for HCR-TDD; time period 1423 (e.g., TDRU#4) is allocated to HCR-TDD; and time period 1424 (TDRU#5) is allocated for uplink for either the first, generic TDD or for HCR-TDD.

On the first, generic TDD side of the frame configuration (indicated by frame configuration 1430):

the frame starts at 1431;

sub-frame #0 to sub-frame #9 are defined as downlink (DL) sub-frames;

sub-frame #10 to sub-frame #19 are defined as uplink (UL) sub-frames;

SCH/BCH is allocated to sub-frame #0 and sub-frame #1;

RACH is allocated to sub-frame #18 and/or sub-frame #19; and

sub-frame #10 to sub-frame #13 are never used (as these sub-frames are defined as UL sub-frames for the UE, and the base station 12 simply does not schedule the UEs 10, 18, 20 to use these sub-frames).

Thus, the sub-frames #18, #19, #0, and #1 are defined as active time periods for the first, generic TDD scheme. The sub-frames #10-#13 are defined as “permanently” inactive time periods while there is coexistence of the two TDD schemes. The sub-frames #2-#9 and #14-#17 may be used by the first, generic TDD scheme (or the HCR-TDD scheme), according to a defined schedule maintained by the base station 12.

On the HCR-TDD side of the frame configuration, as indicated by frame configuration 1440:

the frame starts at 1432;

timeslot #0, timeslot #1, and timeslots #6 to #14 are defined as DL timeslots;

timeslots #2 to #5 are defined as UL timeslots;

SCH/BCH is allocated in timeslot #0;

RACH is allocated in timeslot #2; and

timeslots #7 to #9 are never used (as these timeslots are defined as UL timeslots for the UE, and the base station 12 simply does not schedule the UEs 10, 18, 20 to use these sub-frames).

Thus, the timeslots #0-#2 are defined as active time periods for the HCR-TDD scheme. The timeslots #6-#9 are defined as “permanently” inactive time periods while there is coexistence of the two TDD schemes. The timeslots #10-#14 and #3-#5 may be used by the HCR-TDD scheme (or first, generic TDD scheme), according to a defined schedule maintained by the base station 12.

Other assumed requirements for the first, generic TDD frame structure 1430 are the following. The smallest TDD duplex frame length should be as small as possible, currently 2 ms (four sub-frames) is assumed. This means the system only needs 2 ms to start re-farming. Common control channels (e.g., SCH, BCH, and RS containing Cell ID) can be freely assigned to any timeslot, and these channels should fit into two adjacent sub-frames (1 ms). The time period occupied by the existing TDD system should be confined to the uplink slot of the first, generic TDD frame, if possible. In uplink, the eNode B (evolved Node B, such as base station 12, or a scheduler in PROG 12C or 12F of base station 12) can ensure those timeslots are kept free by simply not allocating them to LTE UEs.

It will be also easier for the eNode B (e.g., base station 12) to perform over-the-air synchronization measurements on these timeslots, if the eNode B needs to obtain frame synchronization information from the SCH signaling of the existing TDD system. It is also noted that the eNode B (e.g., the PROG 12C, possibly in conjunction with PROG 12F) can create the possible configurations for radio resource sharing of FIGS. 11-13 by allocating portions of the time periods 1422, 1424 to the TDD systems. For instance, allocating a larger portion of the time period 1422 to the first, generic TDD (LTE-TDD) system and a smaller portion to the HCR-TDD system will provide a larger percentage of LTE-TDD occupancy.

Thus, FIGS. 8-14 show how the first, generic TDD system can be made, using the techniques described in FIGS. 4-7, to flexibly share resources in time and/or frequency domains with an HCR-TDD system. Note that similar techniques could be used for multiple first, generic TDD systems and HCR-TDD systems.

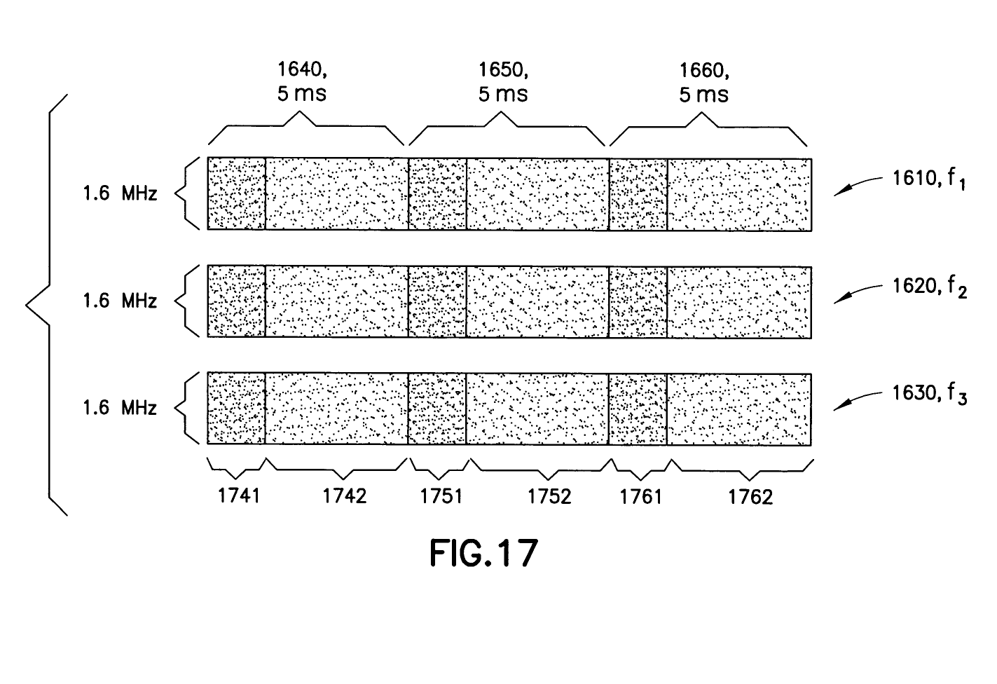

With regard now to the second TDD system, FIGS. 15-19 show how the second TDD system can be made, using the techniques described in FIGS. 4-7, to flexibly share resources in time and/or frequency domains with an LCR-TDD system.

Referring to FIG. 15, a diagram is shown illustrating LCR-TDD radio frames and sub-frames. In LCR-TDD, a 5 ms radio sub-frame (e.g., a duplex frame) is divided into seven timeslots, where each timeslot is 0.675 ms. As a minimum, LCR-TDD needs two timeslots to operate on each 1.6 MHz carrier. TS0 is carrying at least common control physical channel, which includes L2 (layer 2) BCH (broadcast channel), PCI (paging channel), FACH (forward access channel, which is a response to the reverse access channel, RACH). TS0 can be organized as 16 code channels with 16 sub-frames, each of which has an L1 (layer 1) bit rate of 8.8 kbps (kilobits per second). Assuming BCH takes two code channels (17.6 kbps), PCH takes two code channels, FACH takes four code channels, then eight code channels are available for L2 U/C-plane data and L1 control signaling, e.g., power control (PC), spreading factor (SF), and cyclic redundancy check (CRC).

Similarly, four code channels in TS1 are needed to carry RACH. With above assumptions, the remaining capacity for U/C-plane L1 is about 70.4 kbps and 105.6 kbps for DL and UL respectively. This means that within a 5 MHz TDD frequency band, there are a total of 3×7=21 radio resource units to be shared between LCT-TDD and LTE TDD (the second TDD descried herein).

There is therefore a requirement on the second TDD to make the second TDD have a similar variable duplex property as the first, generic TDD described above. To enable coexistence with LCR-TDD, the second TDD should also have the following properties: a minimum operating duration, T0, of two timeslots (one downlink, one uplink with 14 percent occupancy); a maximum operating duration, T1, of seven timeslots (or 5 ms radio sub-frame, which is 100 percent occupancy); and steps of one timeslot (0.675 ms). Further, common channels, such as SCH, BCH, RS (with Cell ID), and RACH, are mapped to the minimum duration, T0. Other channels may occupy a portion or all of a longer duration T2, where T0<=T2<=T1. T2 represents the actual time duration allocated for the second TDD. The value of T2 is cell specific. Depending on need, the value of T2 may be explicitly indicated (e.g., signaled, possibly using the cell-specific time sharing information 21) to the UEs connected to the cell, or the value of T2 may be changed dynamically in the eNode B scheduler.

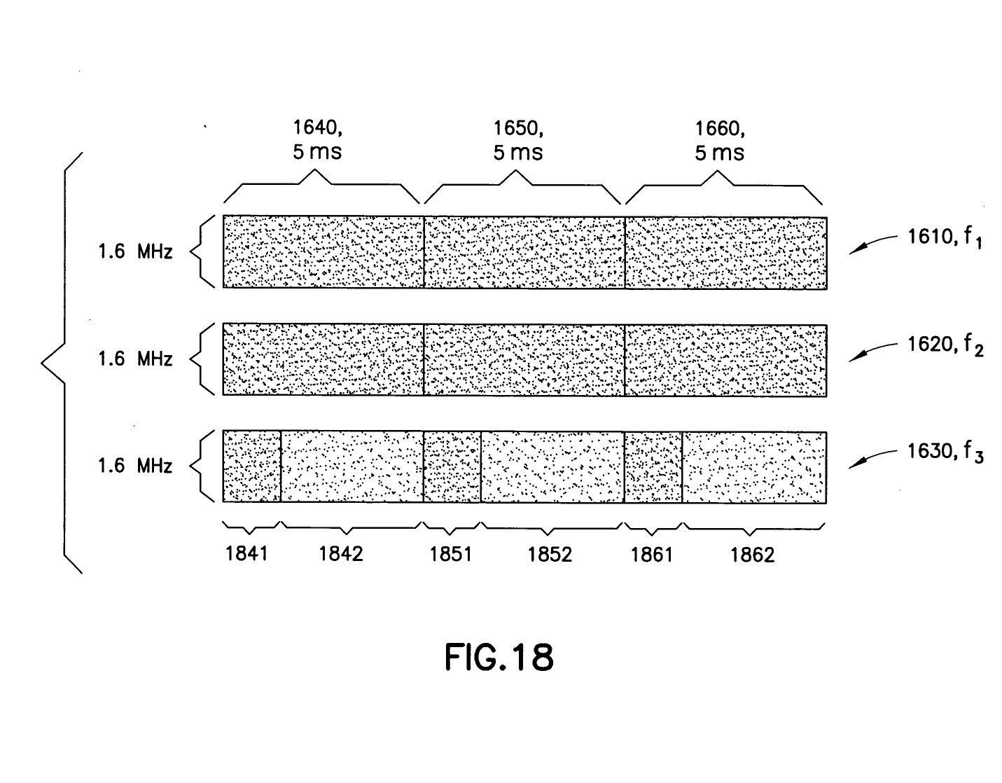

FIGS. 16-18 are figures illustrating possible configurations for radio resource sharing between LCR-TDD and LTE-TDD (i.e., another version of LTE that is the second TDD described herein). FIG. 16 illustrates a cell with coexistence of the LCR-TDD and the second TDD in a 5 MHz TDD frequency band (split into three frequency bands 1610, 1620, and 1630, each operating at a different carrier frequency f₁, f₂, f₃, respectively) with LTE (i.e., the second TDD) occupancy of 43 percent. The time period 1640 is split between time period 1641 for LCR-TDD and time period 1642 for the second TDD. The time period 1650 is split between time period 1651 for LCR-TDD and time period 1652 for the second TDD. The time period 1660 is split between time period 1661 for LCR-TDD and time period 1662 for the second TDD. FIG. 17 illustrates a cell having coexistence between the LCR-TDD and the second TDD in a 5 MHz TDD frequency band with resource split ratio of 70 percent. The time period 1640 is split between time period 1741 for LCR-TDD and time period 1742 for the second TDD. The time period 1650 is split between time period 1751 for LCR-TDD and time period 1752 for the second TDD. The time period 1660 is split between time period 1761 for LCR-TDD and time period 1762 for the second TDD. In FIG. 16, the time period 1641 (for instance) is 57 percent of 5 ms and the time period 1642 is 43 percent of 5 ms. In FIG. 17, the time period 1741 (for instance) is 30 percent of 5 ms and the time period 1742 is 70 percent of 5 ms.

FIG. 18 illustrates a cell having coexistence of the LCR-TDD and the second TDD in a 5 MHz TDD band with LTE (i.e., the second TDD) occupancy of 24 percent. The frequency bands 1610 and 1620 during time periods 1640, 1650, and 1660 are used for LCR-TDD. For frequency band 1630, the time period 1640 is split between time period 1841 for LCR-TDD and time period 1842 for the second TDD; the time period 1650 is split between time period 1851 for LCR-TDD and time period 1852 for the second TDD; the time period 1660 is split between time period 1861 for LCR-TDD and time period 1862 for the second TDD.

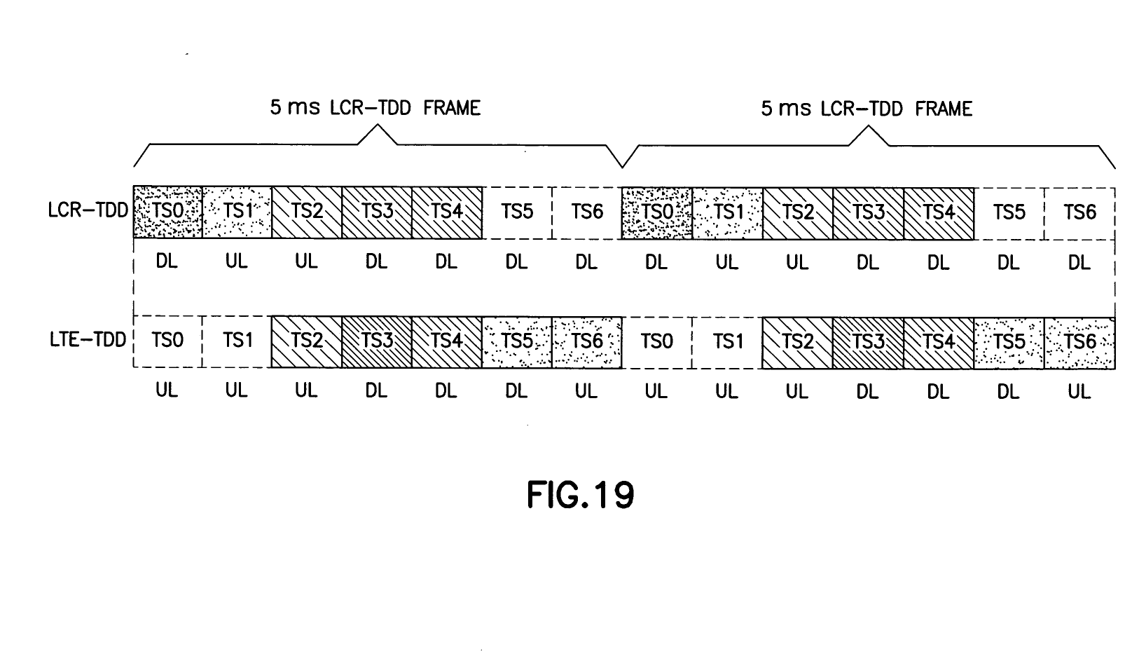

Referring now to FIG. 19, this figure illustrates a possible frame configuration for LCR-TDD and LTE-TDD (the second TDD) in order to coexist in the same network. Timeslot zero and one are permanently allocated to LCR-TDD and are therefore permanently active. Timeslots five and six are permanently allocated to the second TDD (shown as LTE-TDD) and are therefore permanently active. These timeslots are called “the basic timeslots”, i.e., these timeslots must exist as the minimum for the system to operate.

From the perspective of the UE using LCR-TDD, timeslots five and six are configured as DL slots, but these timeslots are just never allocated (e.g., permanently inactive) by the base station 12 (e.g., by a scheduler of the base station 12). From the perspective of the UE using the second TDD), timeslots zero and one are configured as UL slots, but these timeslots are just never allocated (e.g., permanently inactive) by the base station 12 (e.g., by a scheduler of the base station 12). Timeslots two to four can be freely shared (e.g., activated or inactivated) between LCR-TDD and the second TDD, but the two systems should run at approximately the same UL/DL switching point. The sharing of the timeslots two to four is controlled by the base station 12 (e.g., by a scheduler of the base station 12).

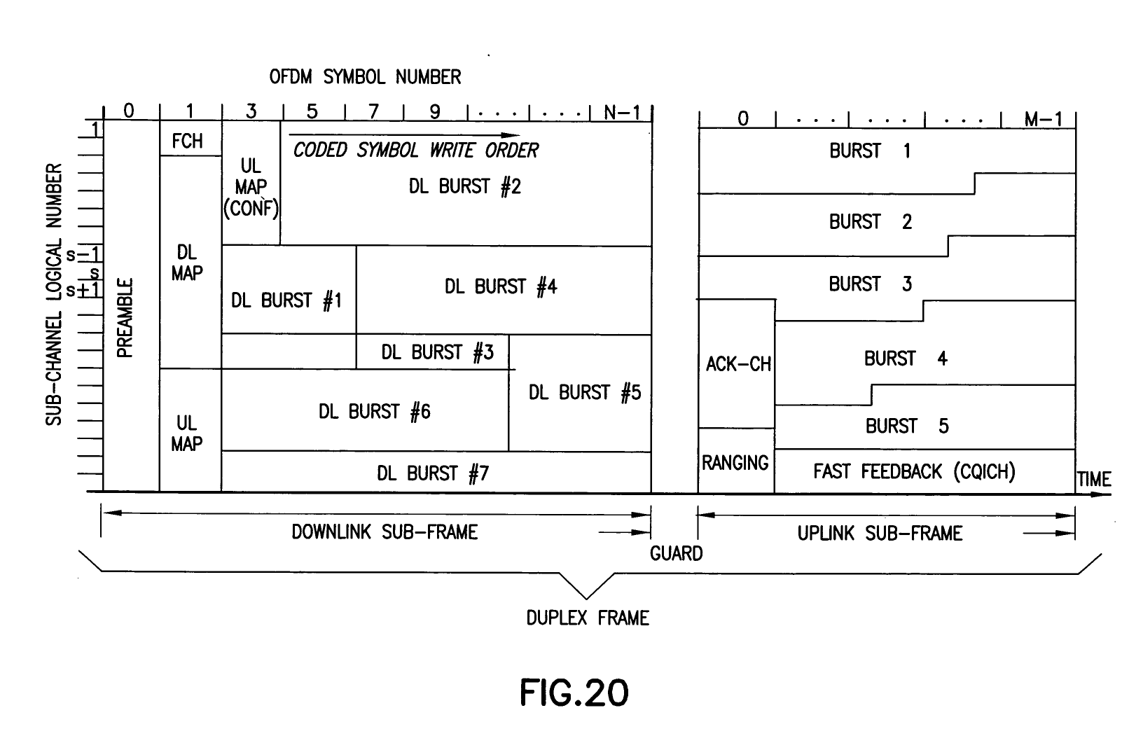

Another example follows of allowing a new LTE-TDD system coexist with an existing Wimax (802.16e) TDD system. Turning to FIG. 20, this figure illustrates a frame for 802.16e. 802.16e has a variable duplex (both UL and DL) frame structure of 2 ms, 2.5 ms, 4 ms, 5 ms, 8 ms, 10 ms, 12.5 ms, and 20 ms. However, the mobile Wimax mobility system profile only specifies operating at 5 ms frame length. Downlink and uplink sub-frames can be placed rather freely. One downlink timeslot includes two orthogonal frequency-division multiplexing (OFDM) symbols, and an uplink timeslot includes three OFDM symbols. OFDM symbol duration for 802.16e is about 0.1029 ms.

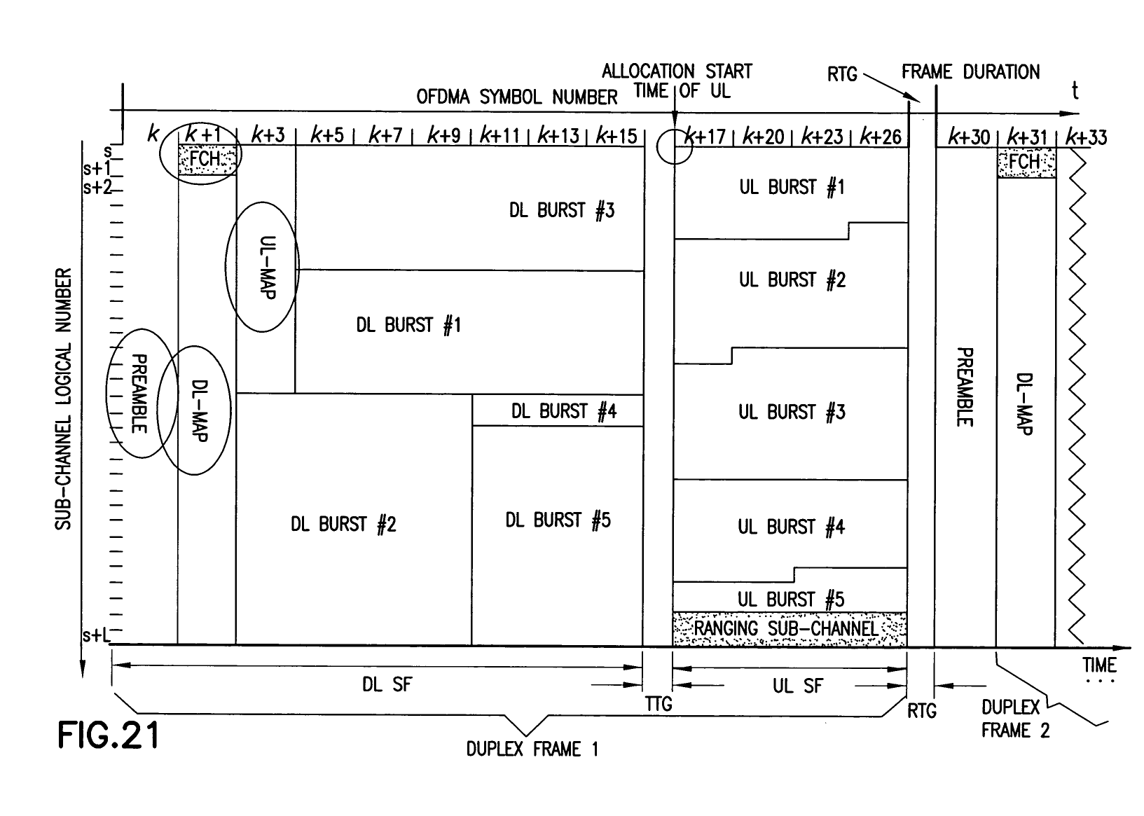

Referring now to FIG. 21, this figure illustrates signaling of frame information to a user equipment using Wimax. A user equipment (e.g., UEs 10, 18, 20) finds the preamble, then determines the fast Fourier transform (FFT), BW (e.g., as defined by a time period), and cyclic prefix (CP). The user equipment also receives the frame control header (FCH), and determines information to decode the DL-MAP. The user equipment receives the DL-MAP, and determines information (e.g., location in the frame) corresponding to the UL-MAP, and determines the frame duration (e.g., using a code). The user equipment receives (e.g., retrieves) the UL-MAP, and determines the allocation start time (of UL) in units of PS=0.357142857 μs (which depends on sampling factor and bandwidth), and the duration in slots. The user equipment receives/retrieves the UL-IEs (information elements) with the uplink interval usage code (UIUC)=0,12,13. These are block allocations with defined length (in time) of FastFeedback, Ranging, Peak-to Average Power Ratio (PAPR) reduction. The user equipment then receives DCD (DL Channel Descriptor), and receive/transmit transition gap (RTG) time in a physical slot (PS), and this time has a maximum value of 91 μs. It is noted that TTG in FIG. 21 stands for Transmit/Receive Transition Gap.

Now that the frame information and frame for Wimax (802.16e) has been described, techniques for providing coexistence of Wimax and LTE-TDD are now described. This example uses the first, “generic” TDD described above. Since the sub-frame length of 1 ms of the first, generic TDD is not compatible with the DL or UL slot length of 802.16e, there is no “perfect” way of sharing resources between the two systems. To support re-farming (e.g., reallocation), one may consider migration in the rough step of, e.g., 1 ms: 1 ms (two sub-frames of the first, generic TDD)=four Wimax DL slots or three Wimax UL slots.

Wimax needs six OFDM symbols to operate, as a minimum: one preamble, two DL symbols, three UL symbols, which is less than 1 ms. The first, generic TDD needs 2 ms (two sub-frames) to operate, as minimum. The remaining 2 ms can be shared between the two systems in different parts of the network and/or different periods of time.

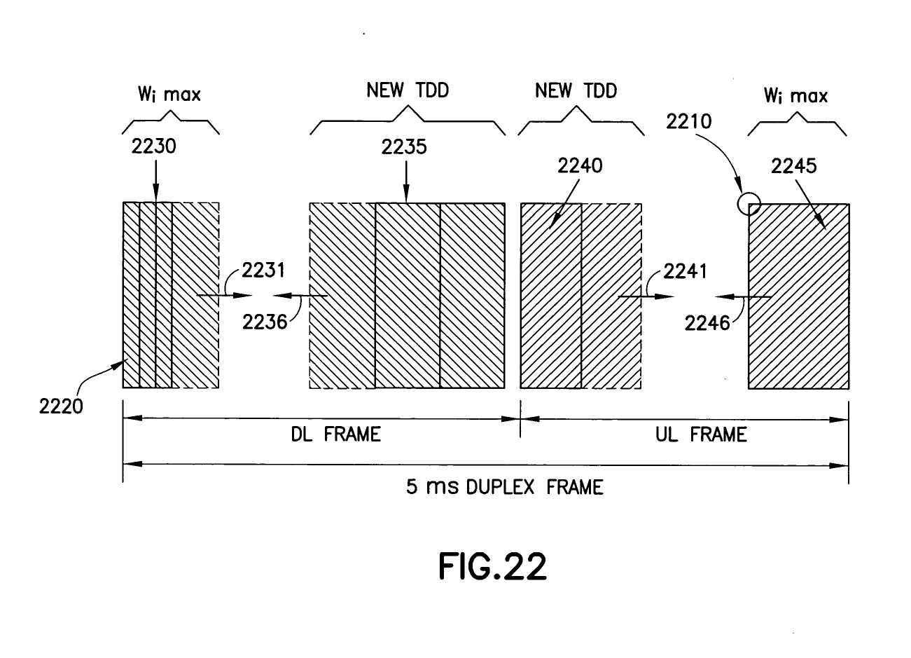

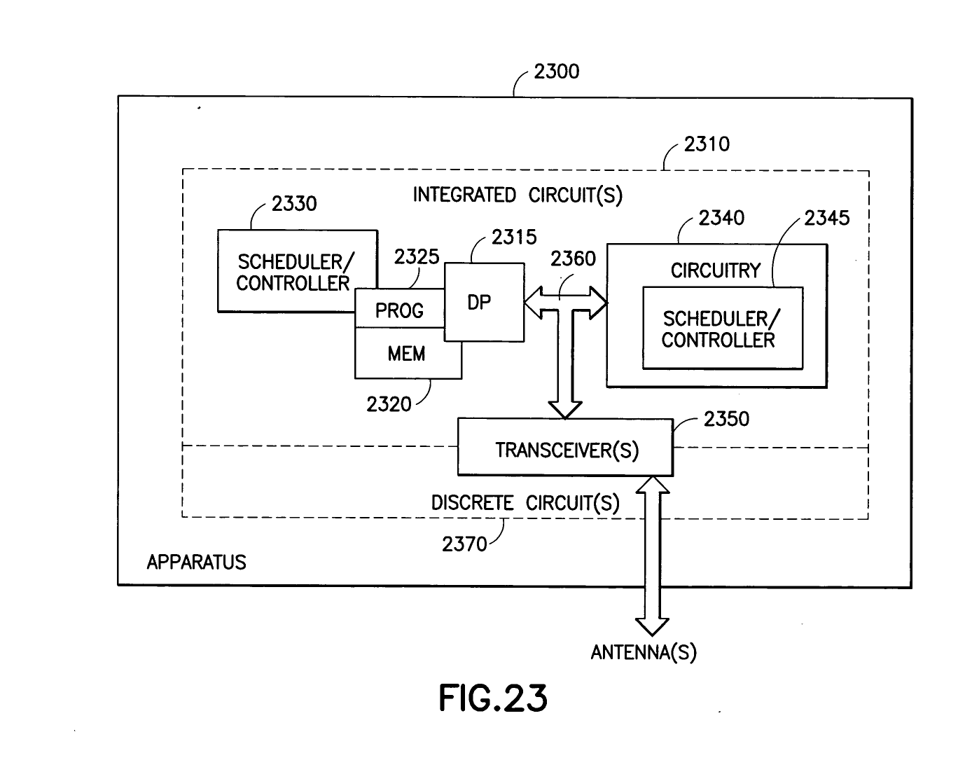

FIG. 22 is a figure illustrating an example of how Wimax and a “new” TDD can coexist on the same carrier. In this example, the new TDD is the first, generic TDD previously described. Reference 2210 illustrates the allocation of the start time of an UL in Wimax. Reference 2220 indicates that one OFDM symbol in Wimax is 0.1029 ms. Reference 2230 indicates that Wimax DL takes 0.3 ms as minimum and increases 2231 in time (during re-farming) by 0.2 ms steps. Reference 2235 indicates that the first, generic TDD DL takes 1 ms as a minimum and increases 2236 in time (during re-farming) by 1 ms steps (one sub-frame). Reference 2240 indicates that the first, generic TDD UL takes 1 ms as a minimum and increases 2241 in time (during re-farming) by 1 ms steps (one sub-frame). Reference 2245 indicates that Wimax UL takes 0.3 ms as a minimum and increases 2246 in time (during re-farming) by 0.3 ms steps (i.e., 3 OFDM symbols). In other words, a scheduler (embodied in, e.g., PROG 12C and/or PROG 12F; see also FIG. 23) in, e.g., an eNode B (such as base station 12) could allocate a larger portion of the DL frame to Wimax by increasing 2231 in time the allocated time period by 0.2 ms steps.

In general, the various embodiments may be implemented in hardware (such as special purpose circuits or logic), software, or any combination thereof. For example, some aspects may be implemented in hardware, while other aspects may be implemented in software which may be executed by a digital processing apparatus (e.g., a controller, microprocessor or other computing device), although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware (special purpose circuits or logic, general purpose hardware or controller or other computing devices), software (e.g., firmware), or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a, standardized electronic format (e.g., Opus, GDSII, or the like) may be transmitted to a semiconductor fabrication facility or “fab” for fabrication.

As an example, FIG. 23 shows a simplified block diagram of a portion of an apparatus 2300 suitable for carrying out exemplary embodiments of the disclosed invention. The apparatus could be one of the UEs 10, 18, 20 or base station 12 (e.g., an eNode B). The apparatus 2300 includes one or more integrated circuits 2310 and one or more discrete circuits 2370. The apparatus 2300 also includes a data processor (DP) 2315, a memory (MEM) 2320 containing a program (PROG) 2325, a bus 2360, circuitry 2340 (e.g., application-specific circuitry), and one or more transceivers 2350. In this example, a portion of the one or more transceivers 2350 includes discrete circuitry 2370 and another portion is formed on integrated circuit(s) 2310. When the apparatus 2300 is a base station 12, the program 2325 includes a scheduler 2330, and the circuitry 2340 includes a scheduler. The scheduler 2330, 2345 performs the techniques described above to provide coexistence of new and existing TDD systems. When the apparatus 2300 is one of the UEs 10, 18, 20, the program 2325 includes a controller 2330, and the circuitry 2340 includes a controller 2340. The controller 2330, 2345 controls the UE to receive and transmit using the new and existing TDD schemes according to a schedule defined by the scheduler. It should be noted that there could be multiple data processors 2315. Additionally, the scheduler/controller 2330, 2345 can be implemented entirely using program 2325, implemented entirely in circuitry 2340, or implemented in both program 2325 and circuitry 2340. The separation between integrated and discrete circuits is also merely exemplary.

The foregoing description has provided by way of exemplary and non-limiting examples a full and informative description of the best techniques presently contemplated by the inventors for carrying out embodiments of the invention. However, various modifications and adaptations may become apparent to those skilled in the relevant arts in view of the foregoing description, when read in conjunction with the accompanying drawings and the appended claims. For instance, another way to use embodiments of this invention is to enable dynamic sharing of time domain resource between a unicast TDD and multi-cast (broadcast) system. One can view a broadcast system (e.g., multimedia broadcast and multicast service, MBMS) running in a TDD band as just another TDD system without any UL resource allocated to the system. Therefore, exemplary embodiments of the invention may also cover the use case where one of the TDD systems only has (for instance) downlink timeslots allocated and no uplink is allocated. For instance, LTE-TDD and LTE Multimedia Multicast/Broadcast Services (MBMS) might share the same RF carrier (i.e., mixed carrier deployment of LTE MBMS). Both Generic TDD and MBMS use the same TDD frame structure of 5 ms duplex space (with 1 ms sub-frame, or timeslot), and the dynamic TDRUs (1 ms each) can be shared between the two systems, only that for MBMS there is no uplink timeslots allocated. One more case could be dynamic time-domain resource sharing with a relay TDD system (a relay or hop is the logic network node which provides the transmission of user traffic to/from Node B upwards into the network, e.g. towards Access GW). All such and similar modifications of the teachings of this invention will still fall within the scope of this invention.

Furthermore, some of the features of exemplary embodiments of this invention could be used to advantage without the corresponding use of other features. As such, the foregoing description should be considered as merely illustrative of the principles of embodiments of the present invention, and not in limitation thereof.

What is claimed is:

1. A method, comprising:
communicating a plurality of first frames using a first communication scheme, each of the first frames having at least one first active time period, wherein communication of the first frames uses a first frequency band; and
communicating a plurality of second frames using a second communication scheme, each of the second frames having at least one second active time period, wherein communication of the second frames uses a second frequency band that at least partially overlaps the first frequency band, and
wherein the communication of the first frames and communication of the second frames operate so that at least a portion of the first and second frames overlap in time but the first and second active time periods do not overlap in time.

2. The method of claim 1, wherein each of the first frames and each of the second frames has the same duration.

3. The method of claim 2, wherein:
the first active time periods occupy a first percentage of the duration and the second active periods occupy a second percentage of the duration;
the at least one second active time period comprises a plurality of second active time periods;
the method further comprises modifying the first percentage and the second percentage by:
deallocating at least one of the plurality of second active time periods; and
allocating at least one new first active time period so that the at least one new first active time period occupies the time period previously occupied by the deallocated at least one second active time period.

4. The method of claim 3, further comprising communicating information corresponding to the deallocation and allocation.

5. The method of claim 1, wherein each of the at least one first active time periods and at least one second active time periods is defined as one of an uplink time period or a downlink time period, and wherein each of the plurality of first frames and the plurality of second frame comprise only downlink time periods or both downlink and uplink time periods.

6. The method of claim 5, wherein the method is performed in a user equipment, and wherein the uplink time period is used to transmit and the downlink time period is used to receive.

7. The method of claim 5, wherein the method is performed in a base station, and wherein the uplink time period is used to receive and the downlink time period is used to transmit.

8. The method of claim 1, wherein either a start of each of the first frames does not align with a start of each of the second frames or a start of each of the first frames aligns with a start of each of the second frames.

9. The method of claim 1, wherein:
the at least one first active time period comprises a plurality of first active time periods; and
the method further comprises:
selecting a suitable time domain resource unit (TDRU) based on a frame structure of the second frames;
configuring a frame structure of the first frames such that mandated physical channels fit into a minimum time period T0, and T0 occupies one or more TDRU;
confining a time period occupied by the at least one active second time period to at least one uplink slot comprising at least one TDRU of the first frames; and
mapping other physical channels into an actual operating time duration that is less than a duration of the frame structure of the first frames and that comprises at least one TDRU.

10. The method of claim 1, wherein:
the at least one first active time period is scheduled as a first uplink time period of a user equipment using the second communication scheme, but a scheduler does not allow the user equipment to use the first uplink time period to communicate using the second communication scheme; and
the at least one second active time period is scheduled as a second uplink time period of a user equipment using the first communication scheme, but a scheduler does not allow the user equipment to use the second uplink time period to communicate using the first communication scheme.

11. The method of claim 1, wherein the first communication scheme comprises a first orthogonal frequency division multiple access (OFDMA) in downlink and single carrier FDMA in uplink, and wherein the second time division communication scheme comprises one of time-division and spread spectrum code-division multiple access or a second OFDMA.

12. The method of claim 1, wherein the first communication scheme comprises a long term evolution time-division duplexing scheme, and wherein the second time division communication scheme comprises one of a high chip rate time-division duplexing scheme, a low chip rate time-division duplexing scheme, or a duplexing scheme defined by 802.16e of institute for electrical and electronics engineers (IEEE) Standard for Local and Metropolitan Area Networks Part 16: Air Interface for Fixed and Mobile Broadband Wireless Access Systems Amendment for Physical and Medium Access Control Layers for Combined Fixed and Mobile Operation in Licensed Bands.

13. The method of claim 1, wherein:
the first communication scheme comprises a long term evolution time-division duplexing scheme;
the second time division communication scheme comprises a time-division duplexing scheme defined by 802.16e of institute for electrical and electronics engineers (IEEE) Standard for Local and Metropolitan Area Networks Part 16: Air Interface for Fixed and Mobile Broadband Wireless Access Systems Amendment for Physical and Medium Access Control Layers for Combined Fixed and Mobile Operation in Licensed Bands;
one of the first frames and one of the second frames occupy a duplex frame having a downlink frame and an uplink frame;
the at least one first active time period comprises a first active uplink portion and a first active downlink portion;
the at least one second active time period comprises a second active uplink portion and a second active downlink portion;
the first active downlink portion starts intermediate the downlink frame and ends proximate an end of the downlink frame;
the second active downlink portion starts proximate a beginning of the downlink frame and ends intermediate the downlink frame;
the first active uplink portion starts proximate a beginning of the uplink frame and ends intermediate the uplink frame; and
the second active uplink portion starts intermediate the uplink frame and ends proximate an end of the uplink frame.

14. The method of claim 13, further comprising reallocating time allocated to each of the first and second frames by performing one or more of:
deallocating a first time period from an end of the second active downlink portion and allocating the first time period to a beginning of the first active downlink portion; and
deallocating a second time period from a beginning of the second active uplink portion and allocating the second time period to an end of the first active uplink portion.

15. The method of claim 1, wherein the first frames are configured so that mandated channels fit into a minimum time period and where other physical channels fit into an actual operating time duration defined by a time duration of the at least one first active time period.

16. An apparatus, comprising:
at least one transceiver; and
at least one controller coupled to the at least one transceiver, the at least one controller configured to cause communication through the at least one transceiver of a plurality of first frames using a first communication scheme, each of the first frames having at least one first active time period, wherein communication of the first frames uses a first frequency band, the at least one controller further configured to cause communication through the at least one transceiver of a plurality of second frames using a second communication scheme, each of the second frames having at least one second active time period, wherein communication of the second frames uses a second frequency band that at least partially overlaps the first frequency band, and wherein the communication of the first frames and communication of the second frames operate so that at least a portion of the first and second frames overlap in time but the first and second active time periods do not overlap in time.

17. The apparatus of claim 16, wherein the apparatus comprises a base station, and wherein the at least one controller comprises a scheduler.

18. The apparatus of claim 17, wherein:
the at least one first active time period is scheduled as a first uplink time period of a user equipment using the second communication scheme, but the scheduler does not allow the user equipment to use the first uplink time period to communicate using the second communication scheme; an
the at least one second active time period is scheduled as a second uplink time period of a user equipment using the first communication scheme, but the scheduler does not allow the user equipment to use the second uplink time period to communicate using the first communication scheme.

19. The apparatus of claim 16, wherein the apparatus comprises at least one of the following: a cellular telephone; a personal digital assistant; a portable computer;
an image capture device; a gaming device; a music storage and playback appliance, and an Internet appliance.

20. The apparatus of claim 16, wherein the at least one controller is formed at least in part in at least one integrated circuit.

21. The apparatus of claim 20, wherein the at least one integrated circuit comprises circuitry suitable for implementing at least a portion of the at least one controller.

22. The apparatus of claim 20, wherein the at least one integrated circuit comprises at least one data processor suitable for implementing at least a portion of the at least one controller when instructions from a program in a memory, coupleable to the at least one data processor, are executed by the at least one data processor.

23. The apparatus of claim 16, wherein the first communication scheme comprises a first orthogonal frequency division multiple access (OFDMA) in downlink and single carrier FDMA in uplink, and wherein the second time division communication scheme comprises one of time-division and spread spectrum code-division multiple access or a second OFDMA.

24. The apparatus of claim 16, wherein the second communication scheme comprises a long term evolution time-division duplexing scheme, and wherein the first time division communication scheme comprises one of a high chip rate time-division duplexing scheme, a low chip rate time-division duplexing scheme, or a duplexing scheme defined by 802.16e of institute for electrical and electronics engineers (IEEE) Standard for Local and Metropolitan Area Networks Part 16: Air Interface for Fixed and Mobile Broadband Wireless Access Systems Amendment for Physical and Medium Access Control Layers for Combined Fixed and Mobile Operation in Licensed Bands.

25. The apparatus of claim 16, wherein:
the at least one second active time period comprises a plurality of second active time periods;
the at least one controller is further configured to modify the first percentage and the second percentage by deallocating at least one of the plurality of second active time periods and allocating at least one new first active time period so that the at least one new first active time period occupies the time period previously occupied by the deallocated at least one second active time period.

26. A computer program product tangibly embodying a program of machine-readable instructions executable by a digital processing apparatus to perform operations comprising:
causing communication of a plurality of first frames using a first communication scheme, each of the first frames having at least one first active time period, wherein communication of the first frames uses a first frequency band; and
causing communication of a plurality of second frames using a second communication scheme, each of the second frames having at least one second active time period, wherein communication of the second frames uses a second frequency band that at least partially overlaps the first frequency band, and
wherein the communication of the first frames and communication of the second frames operate so that at least a portion of the first and second frames overlap in time but the first and second active time periods do not overlap in time.

27. The computer program product of claim 26, wherein the first communication scheme comprises a first orthogonal frequency division multiple access (OFDMA) in downlink and single carrier FDMA in uplink, and wherein the second time division communication scheme comprises one of time-division and spread spectrum code-division multiple access or a second OFDMA.

28. The computer program product of claim 26, wherein the first communication scheme comprises a long term evolution time-division duplexing scheme, and wherein the second time division communication scheme comprises one of a high chip rate time-division duplexing scheme, a low chip rate time-division duplexing scheme, or a duplexing scheme defined by 802.16e of institute for electrical and electronics engineers (IEEE) Standard for Local and Metropolitan Area Networks Part 16: Air Interface for Fixed and Mobile Broadband Wireless Access Systems Amendment for Physical and Medium Access Control Layers for Combined Fixed and Mobile Operation in Licensed Bands.

29. The computer program product of claim 26, wherein:
the at least one second active time period comprises a plurality of second active time periods;
the operations further comprise modifying the first percentage and the second percentage by:
deallocating at least one of the plurality of second active time periods; and
allocating at least one new first active time period so that the at least one new first active time period occupies the time period previously occupied by the deallocated at least one second active time period.

30. An apparatus, comprising:
means for receiving and transmitting; and
means for causing communication through the means for receiving and transmitting of a plurality of first frames using a first communication scheme, each of the first frames having at least one first active time period, wherein communication of the first frames uses a first frequency band, the at least one controller further configured to cause communication through the at least one transceiver of a plurality of second frames using a second communication scheme, each of the second frames having at least one second active time period, wherein communication of the second frames uses a second frequency band that at least partially overlaps the first frequency band, and wherein the communication of the first frames and communication of the second frames operate so that at least a portion of the first and second frames overlap in time but the first and second active time periods do not overlap in time.

31. The apparatus of claim 30, wherein the first communication scheme comprises a first orthogonal frequency division multiple access (OFDMA) in downlink and single carrier FDMA in uplink, and wherein the second time division communication scheme comprises one of time-division and spread spectrum code-division multiple access or a second OFDMA.

32. A method comprising:
using a frame structure of a first time-division duplexing system, selecting a suitable time-domain resource unit (TDRU);
configuring a frame structure of a second time-division duplexing system such that mandated physical channels fit into a minimum time period T0, and T0 occupies one or more TDRU;
confining a time period occupied by the first time-division duplexing system to at least one uplink slot comprising at least one TDRU of the second time-division duplexing system;
mapping other physical channels into an actual operating time duration that is less than a duration of the frame structure of the second time-division duplexing system and that comprises at least one TDRU; and
operating the first and second time-division duplexing systems.

33. The method of claim 32, wherein operating comprises a base station communicating with a first user equipment using the first time-division duplexing system and communicating with a second user equipment using the second time-division duplexing system.

34. The method of claim 32, wherein the second communication scheme comprises a long term evolution time-division duplexing scheme, and wherein the first time division communication scheme comprises one of a high chip rate time-division duplexing scheme, a low chip rate time-division duplexing scheme, or a duplexing scheme defined by 802.16e of institute for electrical and electronics engineers (IEEE) Standard for Local and Metropolitan Area Networks Part 16: Air Interface for Fixed and Mobile Broadband Wireless Access Systems Amendment for Physical and Medium Access Control Layers for Combined Fixed and Mobile Operation in Licensed Bands.

35. The method of claim 32, further comprising modifying the an actual operating time duration by:
deallocating at least a portion of an active time period allocated to the first time-division duplexing system;
correlating the deactivated time period to an inactive time period in the frame structure of the second time-division duplexing system; and
allocating the inactive time period for the second time-division duplexing system.
